(19) United States
(12) Patent Application Publication
(10) Pub. No.: US 2012/0120305 A1
(43) Pub. Date: May 17, 2012

(54) IMAGING APPARATUS, PROGRAM, AND FOCUS CONTROL METHOD

(75) Inventor: Jumpei TAKAHASHI, Tokyo (JP)

(73) Assignee: OLYMPUS CORPORATION, Tokyo (JP)

(21) Appl. No.: 13/291,423

(22) Filed: Nov. 8, 2011

(30) Foreign Application Priority Data
Nov. 17, 2010 (JP) 2010-257025

(51) Int. Cl. H04N 5/232

(52) U.S. Cl. 348/352; 348/349; 348/353; 348/E05.045

(57) ABSTRACT

An imaging apparatus includes an optical system, a first focusing section that controls a focus of the optical system, and performs a first focusing process based on a first evaluation value, a second focusing section that controls the focus of the optical system, and performs a second focusing process based on a second evaluation value, and a focusing process switch section that switches a focusing process between the first focusing process and the second focusing process. The first focusing section includes an in-focus determination section that determines whether or not the first focusing process has been accomplished. The focusing process switch section switches the focusing process from the first focusing process to the second focusing process when the in-focus determination section has determined that the first focusing process has been accomplished.

Japanese Patent Application No. 2010-257025 filed on Nov. 17, 2010, is hereby incorporated by reference in its entirety.

### BACKGROUND

The present invention relates to an imaging apparatus, a program, a focus control method, and the like.

A contrast autofocus (AF) process has been generally used as an AF process for an imaging apparatus. The contrast AF process estimates the object distance based on contrast information detected from the acquired image.

The term “object distance” used herein refers to the in-focus object plane distance of the lens at which the object is in focus. The contrast (contrast information) becomes a maximum when the in-focus object plane distance is equal to the object distance. Therefore, the contrast AF process detects the contrast information from a plurality of images acquired while changing the in-focus object plane position of the lens, and determines the in-focus object plane position at which the detected contrast (contrast information) becomes a maximum to be the object distance.

JP-A-2003-140030 discloses a method that provides an acceleration sensor on the end of the imaging section of the endoscope, and detects the moving direction of the end of the imaging section using the acceleration sensor to detect whether the object distance has changed to the near-point side or the far-point side.

### SUMMARY

According to one aspect of the invention, there is provided an imaging apparatus comprising:

an optical system;

a first focusing section that controls a focus of the optical system, and performs a first focusing process based on a first evaluation value;

a second focusing section that controls the focus of the optical system, and performs a second focusing process based on a second evaluation value; and

a focusing process switch section that switches a focusing process between the first focusing process and the second focusing process,

the first focusing section including an in-focus determination section that determines whether or not the first focusing process has been accomplished, and

the focusing process switch section switching the focusing process from the first focusing process to the second focusing process when the in-focus determination section has determined that the first focusing process has been accomplished.

According to another aspect of the invention, there is provided an information storage medium storing a program that causes a computer to function as:

a first focusing section that controls a focus of an optical system, and performs a first focusing process based on a first evaluation value;

a second focusing section that controls the focus of the optical system, and performs a second focusing process based on a second evaluation value; and

a focusing process switch section that switches a focusing process between the first focusing process and the second focusing process,

the first focusing section including an in-focus determination section that determines whether or not the first focusing process has been accomplished, and

the focusing process switch section switching the focusing process from the first focusing process to the second focusing process when the in-focus determination section has determined that the first focusing process has been accomplished.

According to another aspect of the invention, there is provided a focus control method comprising:

controlling a focus of an optical system, and performing a first focusing process based on a first evaluation value;

controlling the focus of the optical system, and performing a second focusing process based on a second evaluation value;

determining whether or not the first focusing process has been accomplished when switching a focusing process between the first focusing process and the second focusing process; and

switching the focusing process from the first focusing process to the second focusing process when it has been determined that the first focusing process has been accomplished.

### BRIEF DESCRIPTION OF THE DRAWINGS

FIG. 1 shows a first configuration example of an endoscope system.

FIG. 2 shows an arrangement example of color filters of an imaging element.

FIG. 3 shows an example of the transmittance characteristics of color filters of an imaging element.

FIG. 4 is a view illustrative of the depth of field of an imaging element.

FIG. 5 is a view illustrative of the depth of field of a contrast AF process.

FIG. 6 shows a specific configuration example of a first focusing section.

FIG. 7 is a view illustrative of the relative distance of an imaging section and an object.

FIG. 8 is a view illustrative of the relative moving amount of an imaging section and an object.

FIG. 9 shows a first specific configuration example of a second focusing section.

FIG. 10 shows a first specific configuration example of a moving amount detection section.

FIG. 11 shows a first specific configuration example of a switch determination section.

FIG. 12 shows a second specific configuration example of a second focusing section.

FIG. 13 is a view illustrative of a method that detects the moving amount based on frequency characteristics.

FIG. 14 is a view illustrative of a method that detects moving amount based on frequency characteristics.

FIG. 15 is a view illustrative of a method that detects the moving amount based on frequency characteristics.

FIG. 16 shows a second specific configuration example of a moving amount detection section.

FIG. 17 shows a second specific configuration example of a switch determination section.

FIG. 18 shows a third specific configuration example of a second focusing section.

FIG. 19 is a view illustrative of a method that detects the moving amount based on a motion vector.

FIG. 20 is a view illustrative of a method that detects the moving amount based on a motion vector.

FIG. 21 shows a third specific configuration example of a moving amount detection section.

FIG. 22 shows a third specific configuration example of a switch determination section.

FIG. 23 is a system configuration diagram showing the configuration of a computer system.

FIG. 24 is a block diagram showing the configuration of a main body included in a computer system.

FIG. 25 shows an example of a flowchart of software.

### DESCRIPTION OF EXEMPLARY EMBODIMENTS

When using the contrast AF process, it is necessary to acquire a plurality of images while changing the in-focus object plane distance. Therefore, it takes time to determine the focus.

For example, a high-speed AF process is desired for endoscopic diagnosis since the user observes the object while inserting a scope, and a living body (i.e., object) moves (makes a motion) due to the heartbeat or the like. However, a normal contrast AF process takes time to determine the focus. Therefore, the AF process may not sufficiently function when applying a contrast AF process to an endoscope apparatus.

Several aspects of the invention may provide an imaging apparatus, a program, a focus control method, and the like that can increase the speed of an AF process performed by an imaging apparatus.

According to one embodiment of the invention, there is provided an imaging apparatus comprising:

an optical system;

a first focusing section that controls a focus of the optical system, and performs a first focusing process based on a first evaluation value;

a second focusing section that controls the focus of the optical system, and performs a second focusing process based on a second evaluation value; and

a focusing process switch section that switches a focusing process between the first focusing process and the second focusing process,

the first focusing section including an in-focus determination section that determines whether or not the first focusing process has been accomplished, and

the focusing process switch section switching the focusing process from the first focusing process to the second focusing process when the in-focus determination section has determined that the first focusing process has been accomplished.

According to one aspect of the invention, the first focusing process is performed, and the focusing process is switched to the second focusing process when it has been determined that the first focusing process has been accomplished. The second focusing process is then performed. This makes it possible to increase the speed of the AF process performed by the imaging apparatus.

Exemplary embodiments of the invention are described below. Note that the following exemplary embodiments do not in any way limit the scope of the invention laid out in the claims. Note also that all of the elements of the following exemplary embodiments should not necessarily be taken as essential elements of the invention.

### 1. Method

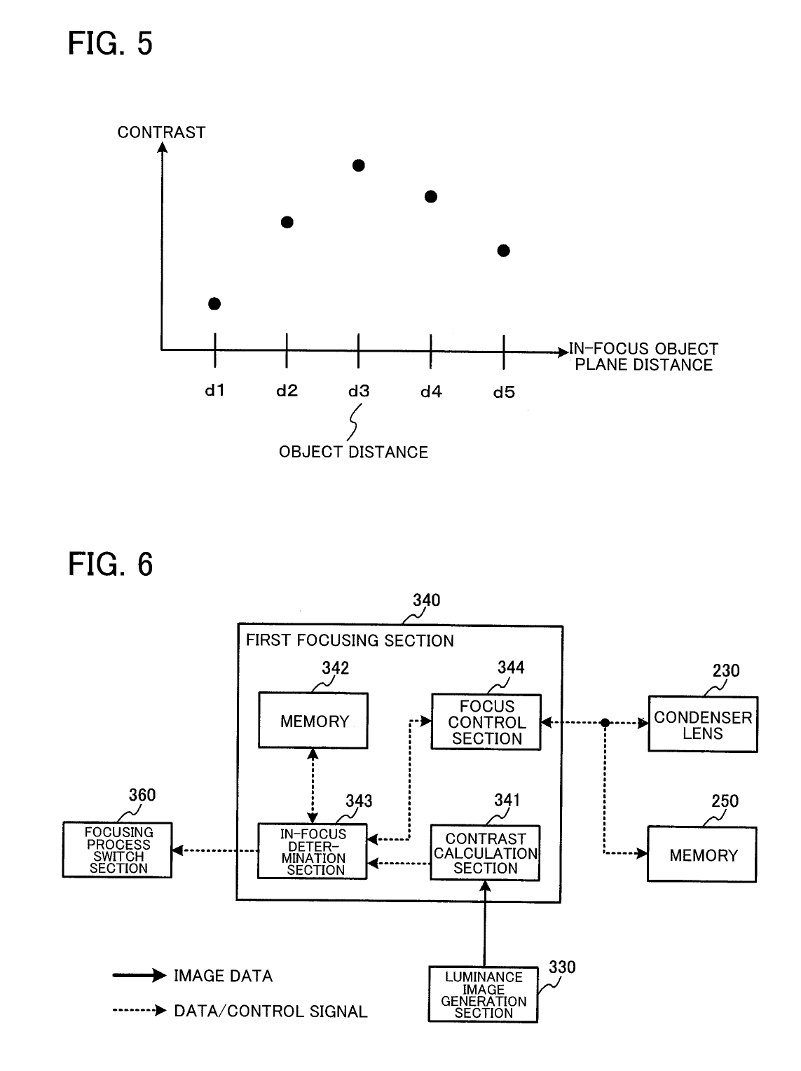

An outline of a focusing process according to several embodiments of the invention is described below. A contrast autofocus (AF) process is performed as follows. As shown in FIG. 5, images are captured using a plurality of in-focus object plane distances d1 to d5, and a contrast value (e.g., high-frequency component or edge quantity) is calculated from the images. A distance among the plurality of distances d1 to d5 at which the contrast value becomes a maximum is determined to be the object distance. Alternatively, the contrast values obtained using the distances d1 to d5 may be interpolated, a distance at which the interpolated contrast value becomes a maximum may be estimated, and the estimated distance may be determined to be the object distance.

When using the contrast AF process, it is necessary to acquire a plurality of images corresponding to the in-focus object plane distances d1 to d5. Therefore, since it is necessary to perform the in-focus object plane distance change operation and the imaging operation a plurality of times, it takes time to determine the focus. For example, since the user of an endoscope observes the object while moving a scope inserted into a body cavity, a lesion may be missed if a long time is required to determine the focus. When observing the object in a state in which the imaging section is positioned right in front of the inner wall of the digestive tract, the distance between the imaging section and the inner wall of the digestive tract changes by the heartbeat and peristaltic motion of the digestive tract. Therefore, high-speed AF process is desired.

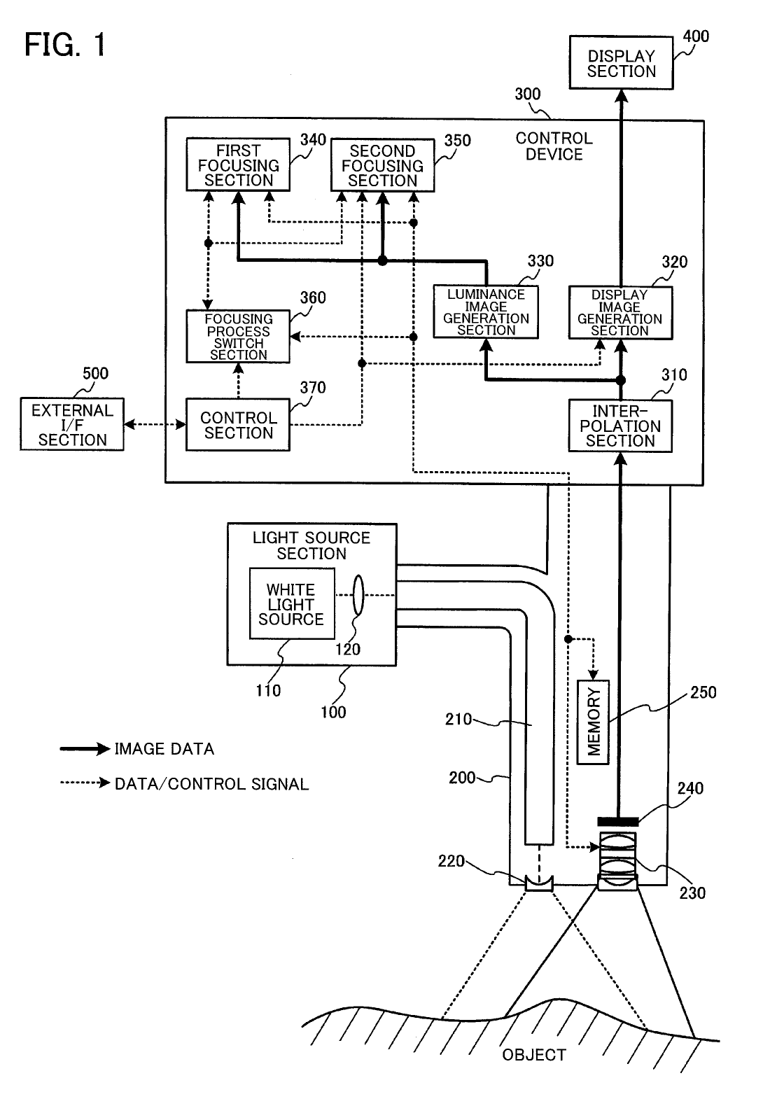

According to several embodiments of the invention, a first focusing section 340 shown in FIG. 1 performs a first focusing process, and a focusing process switch section 360 switches the focusing process to a second focusing process after completion of the first focusing process. The second focusing section 350 then performs the second focusing process. For example, the first focusing process is implemented by a contrast AF process. The second focusing process determines the focus by detecting a change in the distance between the imaging section and the object based on the average luminance of the image, as described later with reference to FIG. 9 and the like. Since the second focusing process calculates the object distance every frame, a high-speed AF process can be implemented as compared with the contrast AF process that requires a plurality of frames.

Note that the term “frame” used herein refers to a timing at which one image is captured by an imaging element, or a timing at which one image is processed by image processing, for example. Note that one image included in image data may be appropriately referred to as “frame”.

### 2. First Embodiment

2.1 First Configuration Example of Endoscope System

FIG. 1 shows a first configuration example of an endoscope system (endoscope apparatus). The endoscope system includes a light source section 100, an imaging section 200, a control device 300 (image processing section), a display section 400, and an external I/F section 500.

The light source section 100 includes a white light source 110 that emits white light, and a lens 120 that focuses the white light on a light guide fiber 210.

The imaging section 200 is formed to be elongated and flexible (i.e., can be curved) so that the imaging section 200 can be inserted into a body cavity or the like. The imaging section 200 is configured to be removable since a different imaging section is used depending on the observation target area (site). The imaging section 200 includes the light guide fiber 210 that guides the light focused by the light source section 100, an illumination lens 220 that diffuses the light that has been guided by the light guide fiber 210, and illuminates an object, a condenser lens 230 that focuses the reflected light from the object, and an imaging element 240 that detects the reflected light focused by the condenser lens 230.

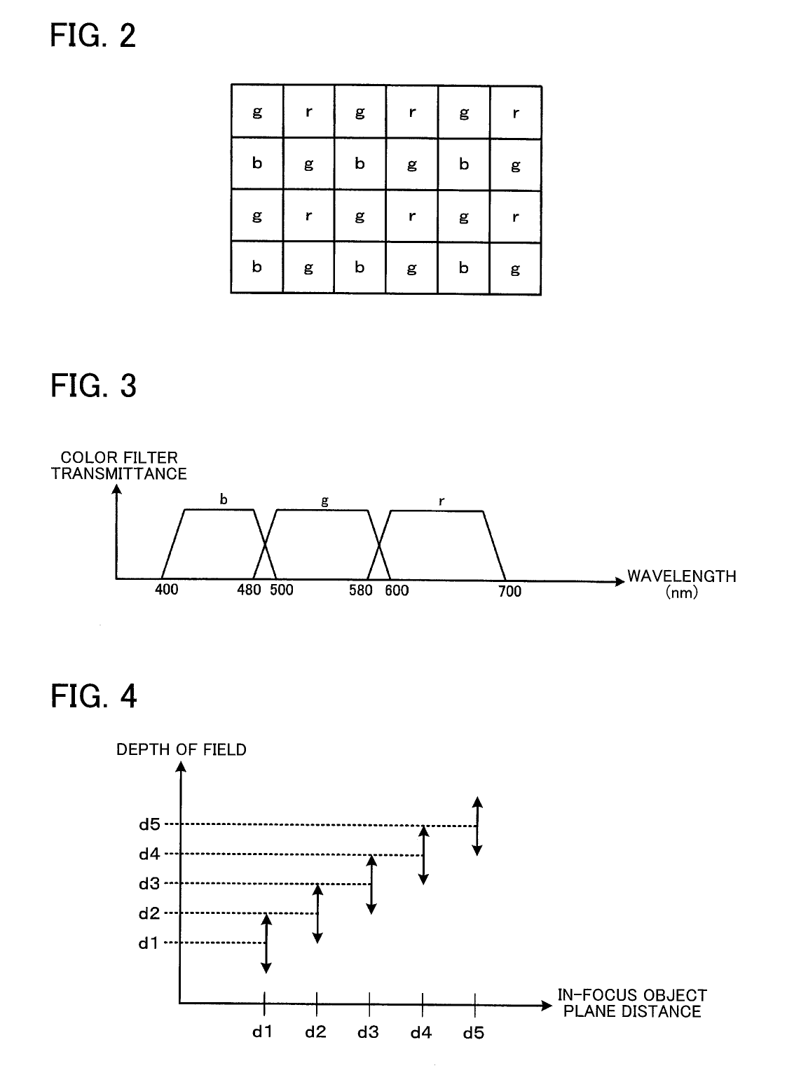

The imaging element 240 has a Bayer color filter array shown in FIG. 2. Color filters r, g, and b shown in FIG. 2 have transmittance characteristics shown in FIG. 3. Specifically, the filter r allows light having a wavelength of 580 to 700 nm to pass through, the filter g allows light having a wavelength of 480 to 600 nm to pass through, and the filter b allows light having a wavelength of 400 to 500 nm to pass through.

The imaging section 200 further includes a memory 250. An identification number of each scope is stored in the memory 250. The type of the connected scope can be identified by referring to the identification number stored in the memory 250.

The in-focus object plane distance of the condenser lens 230 can be variably controlled. For example, the in-focus object plane distance of the condenser lens 230 can be adjusted in five stages (d1 to d5 (mm)). The five-stage distances d1 to d5 (mm) satisfy the relationship shown by the following expression (1). The term “in-focus object plane distance” used herein refers to the distance between the condenser lens 230 and the object in an in-focus state. For example, the condenser lens 230 has a depth of field shown in FIG. 4 at each of the selectable in-focus object plane distances d1 to d5. For example, the depth of field corresponding to the distance d2 is in the range from the distance d1 to the distance d3. Note that the depth of field corresponding to each distance (d1 to d5) is not limited to that shown in FIG. 4. It suffices that the depths of field corresponding to the adjacent in-focus object plane distances overlap.

d5>d4>d3>d2>d1>0 (1)

The in-focus object plane distances of the imaging section 200 differs depending on the connected scope. The type of the connected scope can be identified by referring to the identification number of each scope stored in the memory 250 to acquire in-focus object plane distance information (d1 to d5).

The control device 300 controls each element of the endoscope system, and performs image processing. The control device 300 includes an interpolation section 310, a display image generation section 320, a luminance image generation section 330 (luminance image acquisition section), a first focusing section 340, a second focusing section 350, a focusing process switch section 360, and a control section 370.

The external I/F section 500 is an interface that allows the user to perform an input operation or the like on the endoscope system. The external I/F section 500 includes a power supply switch (power supply ON/OFF switch), a mode (e.g., imaging (photographing) mode) change button, and the like. The external I/F section 500 outputs the input information to the control section 370.

The interpolation section 310 is connected to the display image generation section 320 and the luminance image generation section 330. The luminance image generation section 330 is connected to the first focusing section 340 and the second focusing section 350. The focusing process switch section 360 is bidirectionally connected to the first focusing section 340 and the second focusing section 350, and controls the first focusing section 340 and the second focusing section 350.

The first focusing section 340, the second focusing section 350, and the focusing process switch section 360 are bidirectionally connected to the memory 250 and the condenser lens 230, and control the focus of the condenser lens 230. The control section 370 is connected to the display image generation section 320, the second focusing section 350, and the focusing process switch section 360, and controls the display image generation section 320, the second focusing section 350, and the focusing process switch section 360.

The interpolation section 310 performs an interpolation process on an image acquired (captured) by the imaging element 240. Since the imaging element 240 has the Bayer array shown in FIG. 2, each pixel of the image acquired by the imaging element 240 has the signal value of only one of RGB signals (i.e., the signal values of the other signals are missing).

The interpolation section 310 interpolates the missing signal values by performing the interpolation process on each pixel of the acquired image to generate an image in which each pixel has the signal values of the RGB signals. The interpolation process may be implemented by a known bicubic interpolation process, for example. Note that the image generated by the interpolation section 310 is hereinafter appropriately referred to as “RGB image”.

The interpolation section 310 outputs the generated RGB image to the display image generation section 320 and the luminance image generation section 330.

The display image generation section 320 performs a white balance process, a color conversion process, a grayscale conversion process, and the like on the RGB image output from the interpolation section 310 to generate a display image. The display image generation section 320 outputs the generated display image to the display section 400.

The luminance image generation section 330 generates a luminance image based on the RGB image output from the interpolation section 310. Specifically, the luminance image generation section 330 calculates a luminance signal Y of each pixel of the RGB image using the following expression (2) to generate the luminance image. The luminance image generation section 330 outputs the generated luminance image to the first focusing section 340 and the second focusing section 350.

Y=0.213R+0.715G+0.072B (2)

The first focusing section 340 and the second focusing section 350 detect the focus of the condenser lens 230 using a different method. The focusing process performed by the first focusing section 340 is hereinafter referred to as “first focusing process”, and the focusing process performed by the second focusing section 350 is hereinafter referred to as “second focusing process”. The details of each focusing process are described later.

The focusing process switch section 360 switches the focusing process between two focusing processes. The two focusing processes correspond to the first focusing process and the second focusing process.

The focusing process is switched using a trigger signal. Specifically, the focusing process switch section 360 outputs the trigger signal to the first focusing section 340 when causing the first focusing section 340 to perform the focusing process, and outputs the trigger signal to the second focusing section 350 when causing the second focusing section 350 to perform the focusing process. The focusing process switch section 360 thus switches the focusing process by changing the output destination of the trigger signal. Note that the trigger signal is hereinafter appropriately referred to as “focusing process execution signal”.

The focusing process switch section 360 outputs the focusing process execution signal to the first focusing section 340 in an initial state. The term “initial state” refers to a state when starting the focusing process (e.g., when supplying power or staring a capture (imaging) operation).

The first focusing section 340 detects the focus using the luminance image output from the luminance image generation section 330 when the focusing process execution signal is input from the focusing process switch section 360.

The contrast of the luminance image generally becomes a maximum when the in-focus object plane distance is equal to the object distance. As shown in FIG. 5, when the object distance is the distance d3, for example, the contrast becomes a maximum at the in-focus object plane distance d3 among the in-focus object plane distance d1 to d5. The first focusing section 340 detects the in-focus object plane distance at which the contrast of the luminance image output from the luminance image generation section 330 becomes a maximum as the object distance. For example, a high-frequency component of the luminance image or an output from an arbitrary HPF filter may be used as the contrast value.

Note that the evaluation value used for the first focusing process is not limited to the contrast value as long as the in-focus state can be evaluated. The contrast value is not limited to a high-frequency component of the luminance image or an output from an arbitrary HPF filter. For example, slope information or an edge quantity of the luminance image may be used as the contrast value. The term “slope information” refers to information about the slope of the luminance signal of the luminance image in an arbitrary direction. For example, the difference between the luminance signal of an attention pixel (slope information calculation target) and the luminance signal of at least one peripheral pixel that is positioned away from the attention pixel in the horizontal direction by at least one pixel may be used as the slope of the luminance signal (slope information). A weighted average value of the slope information calculated in a plurality of directions may be used as the edge quantity.

2.2 First Focusing Section

The first focusing process is described in detail below. FIG. 6 shows a specific configuration example of the first focusing section. As shown in FIG. 6, the first focusing section 340 includes a contrast calculation section 341, a memory 342 (storage section), an in-focus determination section 343, and a focus control section 344. The contrast calculation section 341 is connected to the in-focus determination section 343. The focus control section 344 is connected to the in-focus determination section 343, the condenser lens 230, and the memory 250. The memory 342 is bidirectionally connected to the in-focus determination section 343.

The first focusing process is performed as follows (see (i) to (vi)).

(i) The information stored in the memory 342 is set to “0”. A contrast C_mem and an in-focus object plane distance d_mem are stored in the memory 342 (described later).

(ii) The focus control section 344 identifies the connected scope referring to the identification number stored in the memory 250 to acquire the selectable in-focus object plane distance information (d1 to d5) about the condenser lens 230.

(iii) The focus control section 344 sets the in-focus object plane distance of the condenser lens 230 to dm (m is a natural number; the initial value of m is “1”). The focus control section 344 outputs the in-focus object plane distance dm to the in-focus determination section 343.

(iv) The contrast calculation section 341 calculates the contrast C of the luminance image output from the luminance image generation section 330. The contrast calculation section 341 outputs the contrast C to the in-focus determination section 343.

(v) The in-focus determination section 343 compares the contrast C output from the contrast calculation section 341 with the contrast C_mem stored in the memory 342. The in-focus determination section 343 determines the in-focus object plane distance d_mem stored in the memory 342 to be the object distance when the relationship shown by the following expression (3) is satisfied. Note that “|V|” in the expression (3) indicates a process that acquires the absolute value of a real number V.

|C_mem|>|C| (3)

When the relationship shown by the expression (3) is satisfied, the in-focus determination section 343 outputs the in-focus object plane distance d_mem to the focus control section 344, and the focus control section 344 changes the in-focus object plane distance of the condenser lens 230 to the distance d_mem. The in-focus determination section 343 outputs the trigger signal that indicates completion of the focusing process and the contrast C_mem to the focusing process switch section 360.

When the relationship shown by the expression (3) is not satisfied, the in-focus determination section 343 performs the following step (vi).

(vi) When the relationship shown by the expression (3) is not satisfied in the step (v), the in-focus determination section 343 updates the contrast C_mem and the in-focus object plane distance d_mem stored in the memory 342 with C and dm, respectively. The in-focus determination section 343 increments the value m, and returns to the step (iii).

The in-focus determination section 343 determines the distance d5 to be the object distance when the incremented value m is larger than 5. The in-focus determination section 343 outputs the distance d5 to the focus control section 344, and the focus control section 344 changes the in-focus object plane distance of the lens to the distance d5. The in-focus determination section 343 then outputs the trigger signal that indicates completion of the focusing process and the contrast C to the focusing process switch section 360.

Since the first focusing process changes the in-focus object plane distance of the condenser lens 230, and determines the in-focus object plane distance at which the contrast of the luminance image becomes a maximum to be the object distance, the object distance can be detected with high accuracy. However, since it is necessary to acquire a plurality of images in order to detect the object distance, it takes time to detect the object distance.

In order to solve this problem, the first embodiment implements a high-speed focusing process by utilizing the second focusing process that can more quickly detect the object distance after determining the object distance by the first focusing process. The second focusing process is described in detail below.

The focusing process switch section 360 changes the output destination of the focusing process execution signal to the second focusing section 350 when the first focusing section 340 has output the trigger signal that indicates completion of the first focusing process. The focusing process is thus switched from the first focusing process to the second focusing process. The focusing process switch section 360 outputs the contrast value output from the first focusing section 340 to the second focusing section 350.

The second focusing section 350 detects the object distance using the luminance image output from the luminance image generation section 330 when the focusing process execution signal is input from the focusing process switch section 360.

2.3 Second Focusing Section

The second focusing process is described in detail below. A method that detects the relative moving amount of the imaging section and the object based on the luminance of the image is described below.

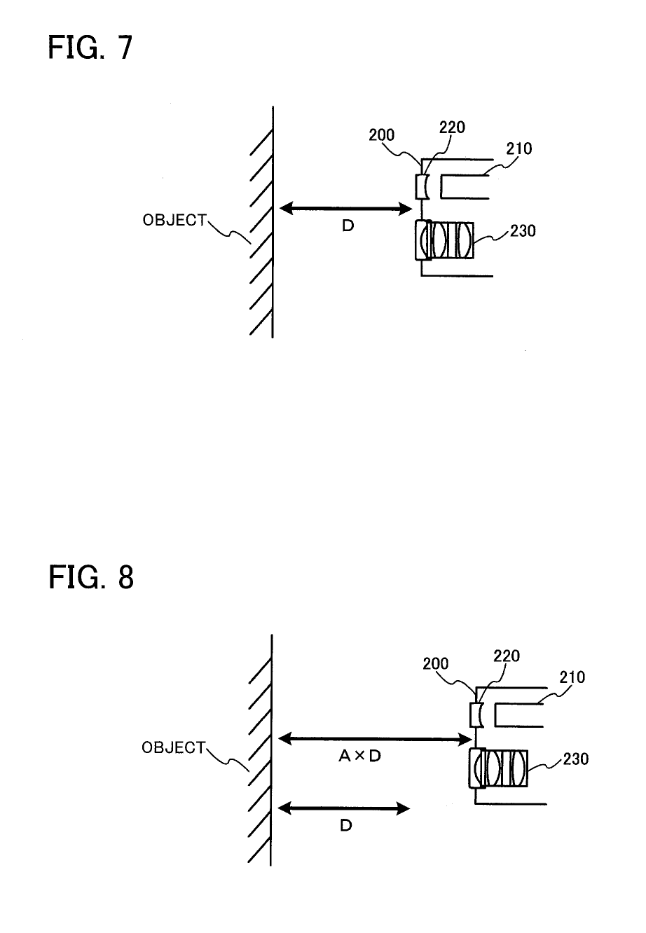

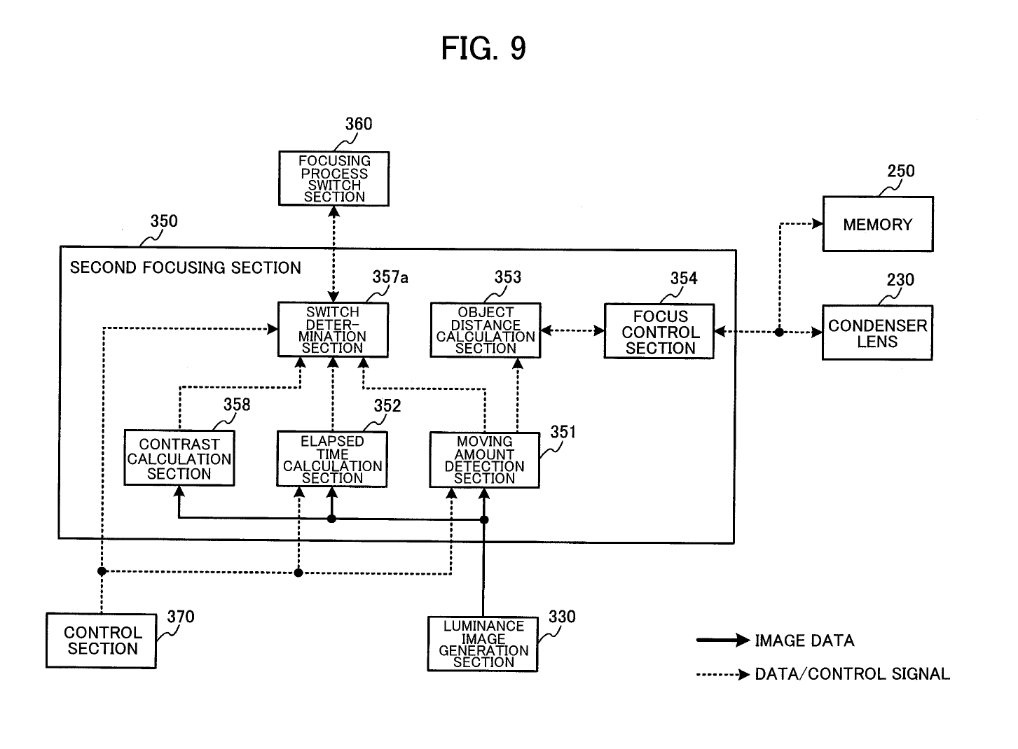

As shown in FIG. 7, the distance between the end of the imaging section 200 and the object at a time t is referred to as D, and the intensity of reflected light focused by the condenser lens 230 is referred to as L_{org}. As shown in FIG. 8, when the distance between the end of the imaging section 200 and the object has changed to D×A at a time t+1, the intensity of reflected light focused by the condenser lens 230 is L_{now}. The time t refers to an exposure timing when capturing an image in a first frame of a moving image, for example. The time t+1 refers to an exposure timing when capturing an image in a second frame of the moving image that is a frame subsequent to the first frame, for example.

The intensity of light generally decreases in inverse proportion to the second power of the distance from the light source. Therefore, the intensity L_{now} of the reflected light when the distance between the end of the imaging section 200 and the object has changed to D×A is calculated by the following expression (4).

$${L}_{now} = \frac{1}{{A}^{2}} {L}_{org} \times \frac{{I}_{now}}{{I}_{org}} \qquad ( 4 )$$

where, A is the relative moving amount of the end of the imaging section 200 and the object at the time t+1 with respect to the distance D between the end of the imaging section 200 and the object at the time t, I_{org} is the intensity of light emitted through the illumination lens 220 at the time t, and I_{now} is the intensity of light emitted through the illumination lens 220 at the time t+1. Since the intensity of light emitted through the illumination lens 220 is constant, the relationship “I_{now}/I_{org}=1” is satisfied.

The average luminance signal of the luminance image output from the luminance image generation section 330 is proportional to the intensity of the reflected light focused by the condenser lens 230 when the object is identical. For example, when the average luminance of the luminance image acquired at the time t is referred to as Y_{org}, and the average luminance of the luminance image acquired at the time t+1 is referred to as Y_{now}, the relationship shown by the following expression (5) is satisfied.

$${Y}_{now} = \frac{1}{{A}^{2}} {Y}_{org} \qquad ( 5 )$$

Therefore, the relative moving amount A with respect to the time t is calculated by the following expression (6) using the average luminance Y_{org} and the average luminance Y_{now}.

$$A = \sqrt{\frac{{Y}_{org}}{{Y}_{now}}} \qquad ( 6 )$$

Although an example in which the intensity of light emitted through the illumination lens 220 is constant has been described above, the moving amount A can also be calculated when changing the intensity of light emitted through the illumination lens 220 with the lapse of time. In this case, the moving amount A can be calculated using the following expression (7).

$$A = \sqrt{\frac{{Y}_{org}}{{Y}_{now}} \times \frac{{I}_{now}}{{I}_{org}}} \qquad ( 7 )$$

FIG. 9 shows a specific configuration example of the second focusing section that performs the focusing process based on the moving amount A. As shown in FIG. 9, the second focusing section 350 includes a moving amount detection section 351, an elapsed time calculation section 352, an object distance calculation section 353, a focus control section 354, a contrast calculation section 358, and a switch determination section 357a.

The moving amount detection section 351 is connected to the object distance calculation section 353 and the switch determination section 357a. The focus control section 354 is connected to the object distance calculation section 353, the condenser lens 230, and the memory 250. The contrast calculation section 358 and the elapsed time calculation section 352 are connected to the switch determination section 357a. The elapsed time calculation section 352, the moving amount detection section 351, and the switch determination section 357a are connected to the control section 370. Note that the contrast calculation section 358 calculates the contrast value by the same process as that of the contrast calculation section 341 (see FIG. 6). Therefore, description of the contrast calculation process is appropriately omitted.

The details of a process performed by the moving amount detection section 351 are described below. The moving amount detection section 351 calculates the relative moving amount A with respect to the initial frame using the expression (6). The initial frame corresponds to the luminance image acquired immediately after the focusing process has been switched to the second focusing process.

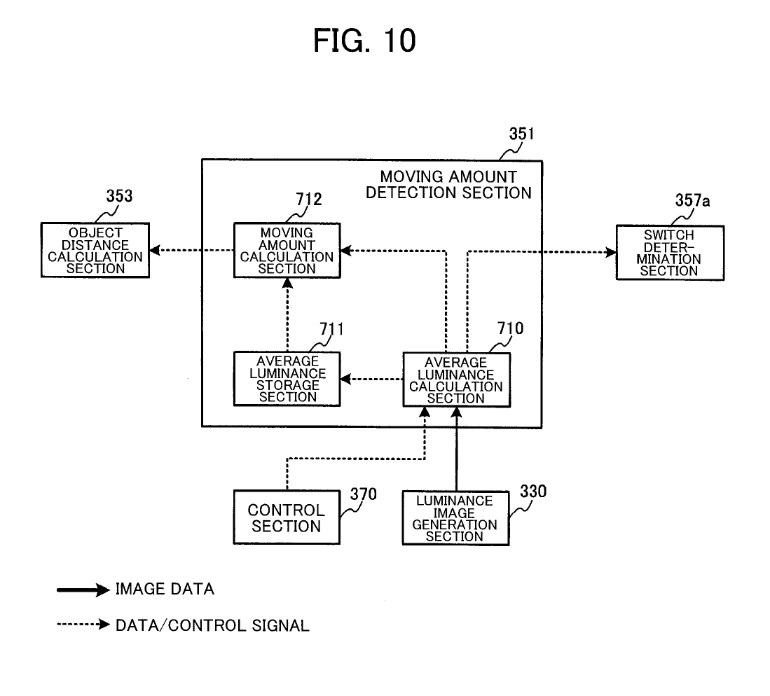

FIG. 10 shows a specific configuration example of the moving amount detection section 351. The moving amount detection section 351 includes an average luminance calculation section 710, an average luminance storage section 711, and a moving amount calculation section 712. The average luminance calculation section 710 is connected to the average luminance storage section 711 and the moving amount calculation section 712. The average luminance storage section 711 is connected to the moving amount calculation section 712. The control section 370 is connected to the average luminance calculation section 710.

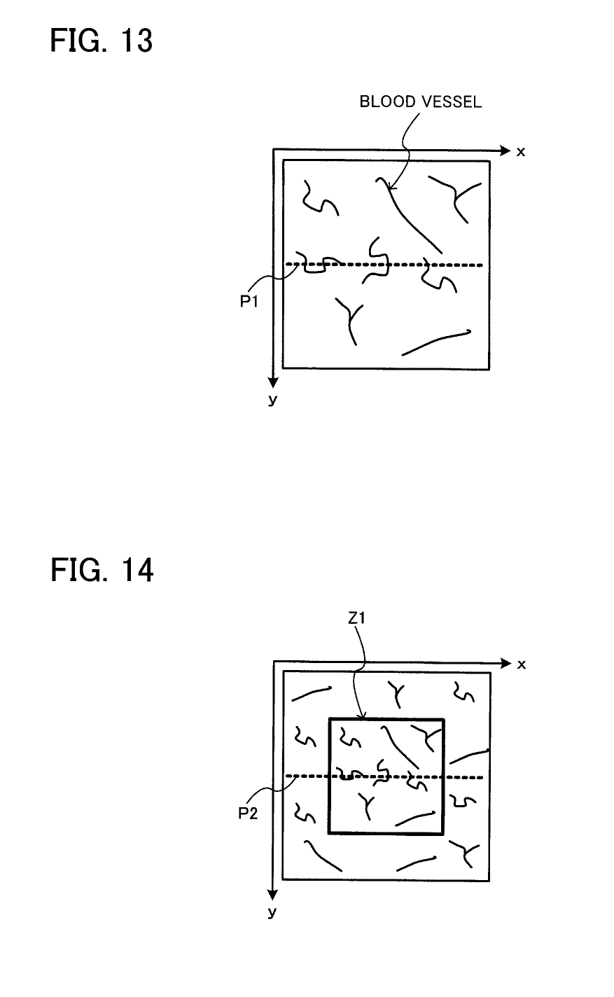

The average luminance calculation section 710 calculates the average luminance Y_{now} based on the luminance image output from the luminance image generation section 330. For example, the average luminance Y_{now} may be the average value of the luminance signal values in a given area of the luminance image (see the following expression (8)).

$${Y}_{now} = \frac{1}{( xe - xs ) \times ( ye - ys )} {\sum }_{x = xs}^{xe} {\sum }_{y = ys}^{ye} Y ( x , y ) \qquad ( 8 )$$

where, Y(x, y) is the luminance signal value at the coordinates (x, y) of the luminance image. (xs, ys) are the coordinates of the starting point of the given area, and (xe, ye) are the coordinates of the end point of the given area. The x-axis and the y-axis are coordinate axes for indicating the coordinates of a pixel within the image. For example, the x-axis and the y-axis are orthogonal axes (see FIG. 13). For example, the x-axis is a coordinate axis that extends along a scan line, and the y-axis is a coordinate axis that perpendicularly intersects the scan line.

The coordinates of the starting point and the end point of the given area (see the expression (8)) may be constant values set (determined) in advance, or may be set by the user via the external I/F section 500. Although an example in which the average luminance Y_{now} is calculated using one given area has been described above, the average luminance Y_{now} may be calculated using a plurality of given areas.

The average luminance calculation section 710 outputs the calculated average luminance Y_{now} to the moving amount calculation section 712 and the switch determination section 357a. The average luminance calculation section 710 outputs the average luminance Y_{now} to the average luminance storage section 711 when the luminance image is a luminance image that corresponds to the initial frame. The average luminance storage section 711 stores the average luminance Y_{now} output from the average luminance calculation section 710 as the average luminance Y_{org}.

The moving amount calculation section 712 calculates the relative moving amount A calculated with respect to the initial frame using the average luminance Y_{now} output from the average luminance calculation section 710, the average luminance Y_{org} stored in the average luminance storage section 711, and the expression (6). The moving amount calculation section 712 outputs the calculated moving amount A to the object distance calculation section 353.

The object distance calculation section 353 calculates the object distance based on the relative moving amount A with respect to the initial frame output from the moving amount detection section 351, and the in-focus object plane distance information output from the focus control section 354. Specifically, the in-focus object plane distance information output from the focus control section 354 includes the in-focus object plane distance d_{org} of the condenser lens 230 in the initial frame, the current in-focus object plane distance d_{now} of the condenser lens 230, and all of the selectable in-focus object plane distances (d1 to d5).

The object distance calculation section 353 calculates the distance dist between the end of the imaging section 200 and the object using the following expression (9).

dist=d_{org}×A (9)

The object distance calculation section 353 changes the in-focus object plane distance corresponding to the distance dist calculated using the expression (9). Specifically, the object distance calculation section 353 determines the in-focus object plane distance that is closest to the distance dist to be an object distance d_{new}. For example, the following expression (10) may be used as the determination expression.

d_{new}=d1 if dist<d1+(d2−d1)/2

d2 else if dist≧d1+(d2−d1)/2 &

dist<d2+(d3−d2)/2

d3 else if dist≧d2+(d3−d2)/2 &

dist<d3+(d4−d3)/2

d4 else if dist≧d3+(d4−d3)/2 &

dist<d4+(d5−d4)/2

d5 else (10)

The object distance calculation section 353 does not change the in-focus object plane distance when the object distance d_{new} is the same as the current in-focus object plane distance d_{now} of the condenser lens 230. The object distance calculation section 353 changes the in-focus object plane distance when the object distance d_{new} differs from the current in-focus object plane distance d_{now}. In this case, the object distance calculation section 353 outputs the object distance d_{new} to the focus control section 354, and the focus control section 354 changes the in-focus object plane distance of the condenser lens 230 to the object distance d_{new}.

The elapsed time calculation section 352 calculates the elapsed time after the focusing process has been switched to the second focusing process. The elapsed time calculation section 352 may count the number F_{NUM} of frames elapsed from the initial frame as the elapsed time, for example. Specifically, the elapsed time calculation section 352 increments the number F_{NUM} of frames using the following expression (11) each time the luminance image is output from the luminance image generation section 330. The initial value of the number F_{NUM} of frames is set to “0”. The elapsed time calculation section 352 outputs the number F_{NUM} of frames to the switch determination section 357a.

F_{NUM}=F_{NUM}+1 (11)

The switch determination section 357a performs a determination process that determines whether or not to switch the focusing process based on the contrast C_{now} output from the contrast calculation section 358, the number F_{NUM} of frames output from the elapsed time calculation section 352, and the average luminance Y_{now} output from the average luminance calculation section 710. The determination process may be implemented by any of three methods described later, for example. When it has been determined to switch the focusing process by the determination process, the switch determination section 357a outputs the trigger signal that indicates that the focusing process should be switched to the focusing process switch section 360.

The focusing process switch section 360 switches the output destination of the focusing process execution signal to the first focusing section 340 when the trigger signal has been input from the switch determination section 357a. The focusing process is thus switched from the second focusing process to the first focusing process.

2.4 Switch Determination Section

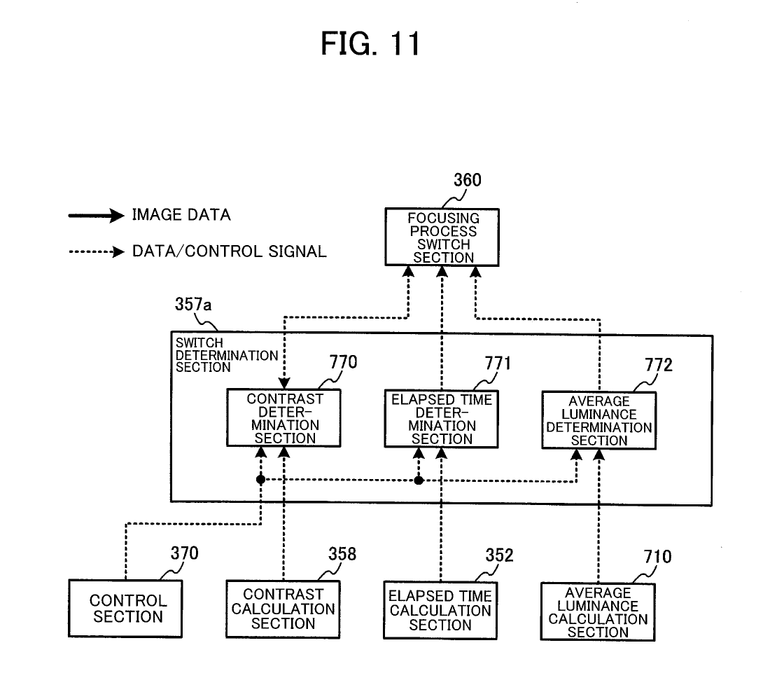

FIG. 11 shows a specific configuration example of the switch determination section 357a. The switch determination section 357a includes a contrast determination section 770, an elapsed time determination section 771, and an average luminance determination section 772. The contrast determination section 770, the elapsed time determination section 771, and the average luminance determination section 772 are connected to the control section 370.

The contrast determination section 770 compares the contrast C_{now} output from the contrast calculation section 358 with the contrast C_{org} output from the focusing process switch section 360. The contrast determination section 770 determines to switch the focusing process when the relationship shown by the following expression (12) is satisfied, and outputs the trigger signal that indicates that the focusing process should be switched to the focusing process switch section 360. Note that C_{TH} in the expression (12) is a real number that satisfies the condition “1>C_{TH}>0”.

C_{TH}×|C_{org}|>|C_{now}| (12)

The elapsed time determination section 771 performs a determination process on the number F_{NUM} of frames output from the elapsed time calculation section 352 using a threshold value F_{TH}. Specifically, the elapsed time determination section 771 determines to switch the focusing process when the condition “F_{NUM}>F_{TH}” is satisfied, and outputs the trigger signal that indicates that the focusing process should be switched to the focusing process switch section 360.

The average luminance determination section 772 performs a determination process on the average luminance Y_{now} output from the average luminance calculation section 710 using threshold values Yₘᵢₙ and Yₘₐₓ. Specifically, the average luminance determination section 772 determines to switch the focusing process when the condition “Y_{now}<Yₘᵢₙ” or “Y_{now}>Yₘₐₓ” is satisfied, and outputs the trigger signal that indicates that the focusing process should be switched to the focusing process switch section 360.

The threshold values F_{TH}, C_{TH}, Yₘᵢₙ, and Yₘₐₓ may be constant values set in advance, or may be set by the user via the external I/F section 500.

According to the first embodiment, the relative moving amount A with respect to the initial frame is calculated based on a temporal change in the average luminance of the luminance image (see the expressions (4) to (6)).

The distance between the end of the imaging section 200 and the object decreases when closely observing the object (i.e., observing the object in a state in which the end of the imaging section 200 is positioned close to the object). Therefore, since the intensity of the reflected light focused by the condenser lens 230 increases, the signal acquired by the imaging element 240 may be saturated. In this case, the luminance image output from the luminance image generation section 330 may also be saturated. Therefore, since the relationship shown by the expression (5) is not satisfied, the moving amount cannot be calculated using the expression (6).

When observing the object from a position away from the object, the intensity of the reflected light focused by the condenser lens 230 decreases. In this case, since the effects of noise increase due to a decrease in the average luminance, an accurate moving amount cannot be calculated.

Specifically, the moving amount cannot be calculated depending on the average luminance. Therefore, the threshold (determination) process is performed on the average luminance Y_{now} output from the average luminance calculation section 710 using the threshold values Yₘᵢₙ and Yₘₐₓ. The focusing process is switched to the first focusing process when it has been determined to switch the focusing process as a result of the threshold (determination) process.

The second focusing process has an advantage in that the object distance can be quickly determined. The second focusing process calculates the object distance on the assumption that the object (i.e., observation target) does not change. However, since an endoscopic diagnosis process diagnoses a plurality of areas (sites), the object (i.e., observation target) changes every given time.

Therefore, when applying the second focusing process to an endoscope system, the detection accuracy of the object distance may deteriorate when the object has changed. In this case, it is expected that the contrast of the luminance image output from the luminance image generation section 330 decreases. According to the first embodiment, the contrast C_{now} is detected from the luminance image output from the luminance image generation section 330 even after the focusing process has been switched to the second focusing process, and the focusing process is switched to the first focusing process when the contrast C_{now} is lower than the value “C_{TH}×|C_{org}|”.

According to the first embodiment, the focusing process is switched to the first focusing process when a given time has elapsed after the focusing process has been switched to the second focusing process. Specifically, the number F_{NUM} of frames output from the luminance image generation section 330 is counted using the expression (11) after the focusing process has been switched to the second focusing process. The focusing process is switched from the second focusing process to the first focusing process when the number F_{NUM} of frames has exceeded the threshold value F_{TH}.

It is possible to quickly control the focus while detecting the object distance with high accuracy by utilizing the above method. This makes it unnecessary for the doctor to manually adjust the focus, so that the burden on the doctor can be reduced. Moreover, since a high-contrast image can be necessarily provided, a situation in which the lesion is missed can be prevented.

An example in which the focus is controlled has been described above. Note that it is mainly necessary to control the focus during endoscopic diagnosis when utilizing magnifying observation. Therefore, the focus may be controlled only during magnifying observation.

The user may switch the observation mode between magnifying observation and normal observation using the external OF section 500, for example. In this case, the focusing process switch section 360 does not output the focusing process execution signal to the first focusing section 340 and the second focusing section 350 during a period in which normal observation is selected. The focusing process switch section 360 compulsorily sets the in-focus object plane distance of the condenser lens to the distance d5 when normal observation has been selected. The distance d5 is used as the in-focus object plane distance during normal observation.

Since the contrast AF process must acquire a plurality of images corresponding to a plurality of in-focus object plane distances, it is necessary to perform the in-focus object plane distance change operation and the imaging operation a plurality of times.

As shown in FIG. 1, the imaging apparatus according to the first embodiment includes the optical system, the first focusing section 340 that controls the focus of the optical system, and performs the first focusing process, the second focusing section 350 that controls the focus of the optical system, and performs the second focusing process, and the focusing process switch section 360 that switches the focusing process between the first focusing process and the second focusing process. As shown in FIG. 6, the first focusing section 340 includes the in-focus determination section 343 that determines whether or not the first focusing process has been accomplished. The focusing process switch section 360 switches the focusing process to the second focusing process when the in-focus determination section 343 has determined that the first focusing process has been accomplished.

The optical system is an optical system for which the focus can be controlled. In the first embodiment, the optical system corresponds to the condenser lens 230 shown in FIG. 1. The expression “the first focusing process has been accomplished” means that the first focusing process has ended, or it has been determined that an in-focus state has been reached, for example. For example, when using the contrast AF process, it is determined that the first focusing process has been accomplished when the in-focus object plane distance has been set to the in-focus object plane distance corresponding to the maximum contrast value.

According to the first embodiment, it is possible to increase the speed of the AF process performed by the imaging apparatus. Specifically, the speed of the AF process can be increased by switching the focusing process to the second focusing process that can quickly implement an in-focus state as compared with the first focusing process. For example, the first focusing process is an AF process that requires a plurality of frames until an in-focus state is reached, and the second focusing process is an AF process in which an in-focus state is reached every frame.

The second focusing process can be started from the in-focus initial frame by switching the focusing process to the second focusing process when it has been determined that the first focusing process has been accomplished. This makes it possible to maintain the in-focus state based on the moving amount (change in distance) between the imaging section and the object with respect to the initial frame.

As shown in FIG. 1, the imaging apparatus according to the first embodiment includes the imaging section 200 that (successively) acquires images in time series. The focusing process switch section 360 allows the first focusing section 340 to continue the first focusing process until it has been determined that the first focusing process has been accomplished. The focusing process switch section 360 switches the focusing process performed on a subsequently-acquired image to the second focusing process performed by the second focusing section 350 when it has been determined that the first focusing process has been accomplished.

In the first embodiment, the imaging element 240 having a Bayer array captures images in time series, and the interpolation section 310 (image acquisition section in a broad sense) performs the interpolation process to acquire RGB images (moving image) in time series. The focusing process switch section 360 allows the first focusing section 340 to continue the first focusing process by outputting the focusing process execution signal to the first focusing section 340, and switches the focusing process to the second focusing process by outputting the focusing process execution signal to the second focusing section 350.

This makes it possible to implement an in-focus state by the first focusing process using images captured in time series, and switch the focusing process to the second focusing process when an in-focus state has been implemented, and then capture images in time series.

The imaging section 200 acquires images in time series using the in-focus object plane distances d1 to d5. The first focusing section 340 calculates the contrast values (evaluation values for evaluating the in-focus state in a broad sense) of the images acquired in time series using the in-focus object plane distances d1 to d5, and performs the first focusing process based on the calculated contrast values to control the focus of the optical system. The second focusing section 350 performs the second focusing process on each of images acquired in time series after the focusing process has been switched to the second focusing process. The second focusing section 350 detects the relative moving amount A (or A′ or Aₐₗₗ) of the imaging section 200 and the object, and controls the focus of the optical system based on the detected moving amount A.

This makes it possible to perform the contrast AF process as the first focusing process, and perform the focusing process based on the relative moving amount of the imaging section and the object as the second focusing process. Since the second focusing process performs the focusing process on each image (each frame), a high-speed AF process can be implemented as compared with the contrast AF process that requires a plurality of frames.

As shown in FIG. 9, the second focusing section 350 includes the switch determination section 357a that determines whether or not to switch the focusing process based on the parameter for evaluating the in-focus state during the second focusing process. The focusing process switch section 360 switches the focusing process from the second focusing process to the first focusing process based on the determination result of the switch determination section 357a.

This makes it possible to switch the focusing process from the second focusing process to the first focusing process. Specifically, it is possible to determine the possibility that the focusing accuracy has deteriorated by utilizing the parameter for evaluating the in-focus state. This makes it possible to switch the focusing process from the second focusing process to the first focusing process, and reliably recover the in-focus state.

The parameter used by the switch determination section is the control parameter used for the second focusing process.

The control parameter is a parameter that is acquired or calculated during the second focusing process. For example, the control parameter is the average luminance Ynow, a frequency characteristic matching error ε (described later), a motion vector matching error SADₘᵢₙ (described later), or the like.

Since the control parameter is a value used to calculate the object distance, the in-focus state during the second focusing process can be evaluated by utilizing the control parameter. This makes it possible to determine whether or not to switch the focusing process based on the in-focus state during the second focusing process.

As shown in FIG. 9, the second focusing section 350 includes the contrast calculation section 358 that calculates the contrast value based on the acquired image. The switch determination section 357a determines whether or not to switch the focusing process using the contrast value as a parameter.

For example, the switch determination section 357a determines to switch the focusing process to the first focusing process when the contrast value is smaller than the threshold value C_{TH}.

This makes it possible to switch the focusing process to the first focusing process based on the contrast value. Since the contrast value decreases as the image becomes out of focus, the in-focus state can be evaluated by utilizing the contrast value.

As shown in FIG. 10, the second focusing section 350 includes the average luminance calculation section 710 that calculates the average luminance Y_{now} of the acquired image. The switch determination section 357a determines whether or not to switch the focusing process using the average luminance Y_{now} as a parameter.

For example, the switch determination section 357a determines to switch the focusing process to the first focusing process when the average luminance Y_{now} is larger than threshold value Yₘₐₓ, or when the average luminance Y_{now} is smaller than the threshold value Yₘᵢₙ.

This makes it possible to switch the focusing process to the first focusing process based on the average luminance of the image. For example, it is like that blown out highlights occur when the luminance is too high, and it is like that the S/N ratio of the image has deteriorated when the luminance is too low. In such a case, the moving amount calculation accuracy from the image deteriorates. For example, when estimating the moving amount from the average luminance, the estimation accuracy deteriorates due to blown out highlights or a deterioration in S/N ratio. Therefore, it is possible to determine whether or not to switch the focusing process to the first focusing process using the threshold values Yₘₐₓ and Yₘᵢₙ, and reliably recover the in-focus state by switching the focusing process to the first focusing process.

As shown in FIG. 9, the second focusing section 350 includes the elapsed time calculation section 352 (elapsed time measurement section) that measures the elapsed time after the focusing process switch section 360 has switched the focusing process to the second focusing process. The switch determination section 357a determines whether or not to switch the focusing process using the elapsed time as a parameter.

For example, the elapsed time calculation section 352 counts the number F_{NUM} of frames as the elapsed time, and the focusing process is switched when the number F_{NUM} of frames has exceeded the threshold value F_{TH}. Note that the elapsed time is not limited to the number of frames, but may be information that indicates a clock signal count value or the like.

This makes it possible to switch the focusing process to the first focusing process based on the elapsed time. For example, the observation position may have moved with the lapse of time. Alternatively, when integrating the inter-frame moving amount (described later), an error may accumulate with the lapse of time. It is possible to reliably recover the in-focus state by switching the focusing process to the first focusing process based on the elapsed time.

As shown in FIG. 9, the second focusing section 350 includes the moving amount detection section 351 that detects the relative moving amount A of the imaging section 200 and the object. The second focusing section 350 controls the focus of the optical system based on the moving amount A. Specifically, the moving amount detection section 351 detects the moving amount A based on a temporal change in the image signal of the acquired image. More specifically, the imaging section 200 acquires a first image and a second image in time series. The moving amount detection section 351 detects the moving amount A using the ratio of the average luminance value Y_{org} of the first image to the average luminance value Y_{now} of the second image as a temporal change in the image signal (see the expression (6)).

This makes it possible to detect the moving amount using the moving amount detection section, and control the in-focus object plane distance to the object distance based on the moving amount. Moreover, the moving amount can be calculated by image processing by utilizing a temporal change in the image signal. It is also possible to calculate the moving amount using the relationship between the illumination light and the distance by utilizing the inter-frame average luminance ratio. Note that a temporal change in the image signal is not limited to the average luminance value, but may be an amount that changes corresponding to a change in the distance between the imaging section and the object.

The optical system changes the focus by selecting one in-focus object plane distance from a given plurality of in-focus object plane distances (d1 to d5).

Specifically, the first focusing section 340 calculates the contrast value of an image acquired using each of the given plurality of in-focus object plane distances (d1 to d5), and changes the in-focus object plane distance of the optical system to the in-focus object plane distance at which the highest contrast value is obtained. The second focusing section 350 selects an in-focus object plane distance that is closest to the object distance calculated by the second focusing process from the given plurality of in-focus object plane distances (d1 to d5), and changes the in-focus object plane distance of the optical system to the selected distance.

The optical system may perform a zoom process. The first focusing section 340 performs the first focusing process in a magnifying observation mode in which the magnification of the zoom process is set to be higher than that employed in a normal observation mode. The second focusing section 350 performs the second focusing process in the magnifying observation mode.

For example, the observation mode is set corresponding to the zoom magnification of the optical system that is set using a zoom adjustment knob. For example, the observation mode is set to the normal observation mode when the magnification is set to the lowest magnification within the variable range of the zoom magnification. The observation mode is set to the magnifying observation mode when the magnification is set to a magnification higher than the lowest magnification. In the normal observation mode, a lesion is searched at a low magnification while moving the imaging section inside the digestive tract (normal observation). In the magnifying observation mode, the lesion is observed at a high magnification in a state in which the imaging section is positioned right in front of the inner wall of the digestive tract (magnifying observation).

This makes it possible to easily to maintain the in-focus state even if a high zoom magnification has been set (e.g., a narrow depth of field has been set) by performing an AF process by the first focusing process and the second focusing process in the magnifying observation mode.

The second focusing section 350 does not change the in-focus object plane distance of the optical system when the moving amount is smaller than a threshold value.

For example, an in-focus object plane distance that is closest to the calculated object distance dist is selected from the given plurality of in-focus object plane distances (d1 to d5) (see the expression (10)). In this case, when the object distance in the preceding frame is the distance d2, the distance d2 is selected again when the relationship “d1+(d2−d1)/2≦dist<d2+(d3−d2)/2” is satisfied. Specifically, the in-focus object plane distance of the optical system is not changed when a change in the moving amount is within the above range.

### 3. Second Embodiment

The first embodiment has been described taking an example in which the relative moving amount with respect to the initial frame is detected using the expression (6) based on the average luminance of the luminance image. In a second embodiment, the moving amount may be detected based on the frequency characteristics of the luminance image.

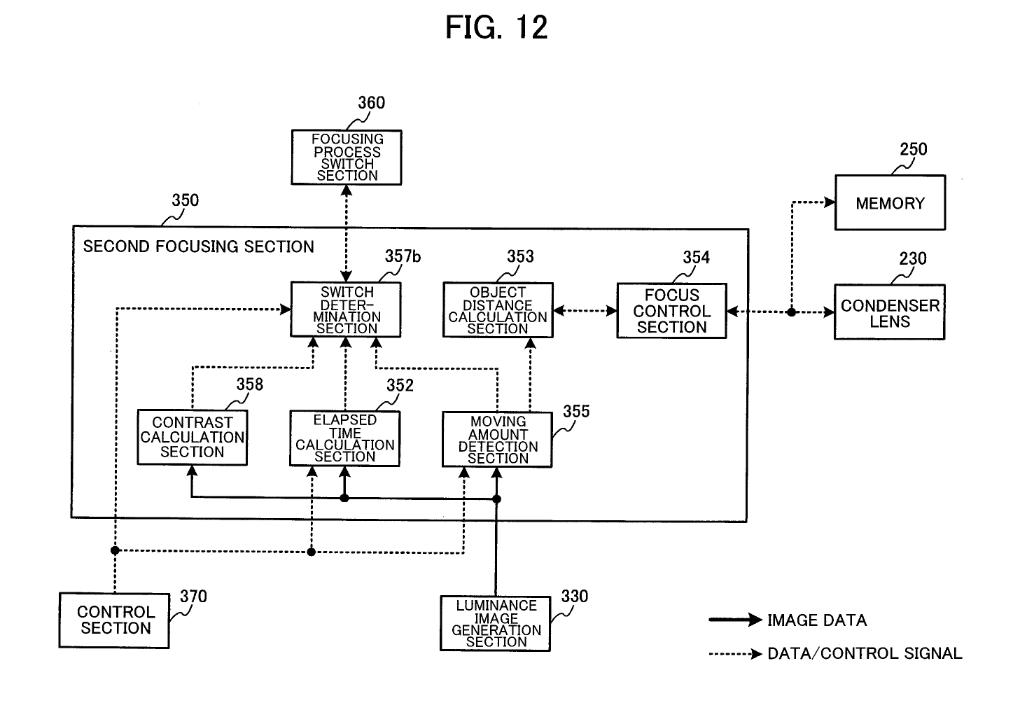

FIG. 12 shows a second specific configuration example of the second focusing section 350. The second focusing section 350 includes a moving amount detection section 355, an elapsed time calculation section 352, an object distance calculation section 353, a focus control section 354, a contrast calculation section 358, and a switch determination section 357b. Note that the basic configuration of the endoscope system is the same as that described above in connection with the first embodiment, and the processes other than the process performed by the second focusing section 350 are the same as those described above in connection with the first embodiment. Description of the same configuration and the same processes as those described above in connection with the first embodiment are appropriately omitted. The processes other than the processes performed by the moving amount detection section 355 and the switch determination section 357b are the same as those described above in connection with the first embodiment. Description of the same processes as those described above in connection with the first embodiment are appropriately omitted.

The relationship between the frequency characteristics of the luminance image and the moving amount is described below. Suppose that an image shown in FIG. 13 has been acquired by the luminance image generation section 330 when the distance between the end of the imaging section 200 and the object at a time t is D (see FIG. 7).

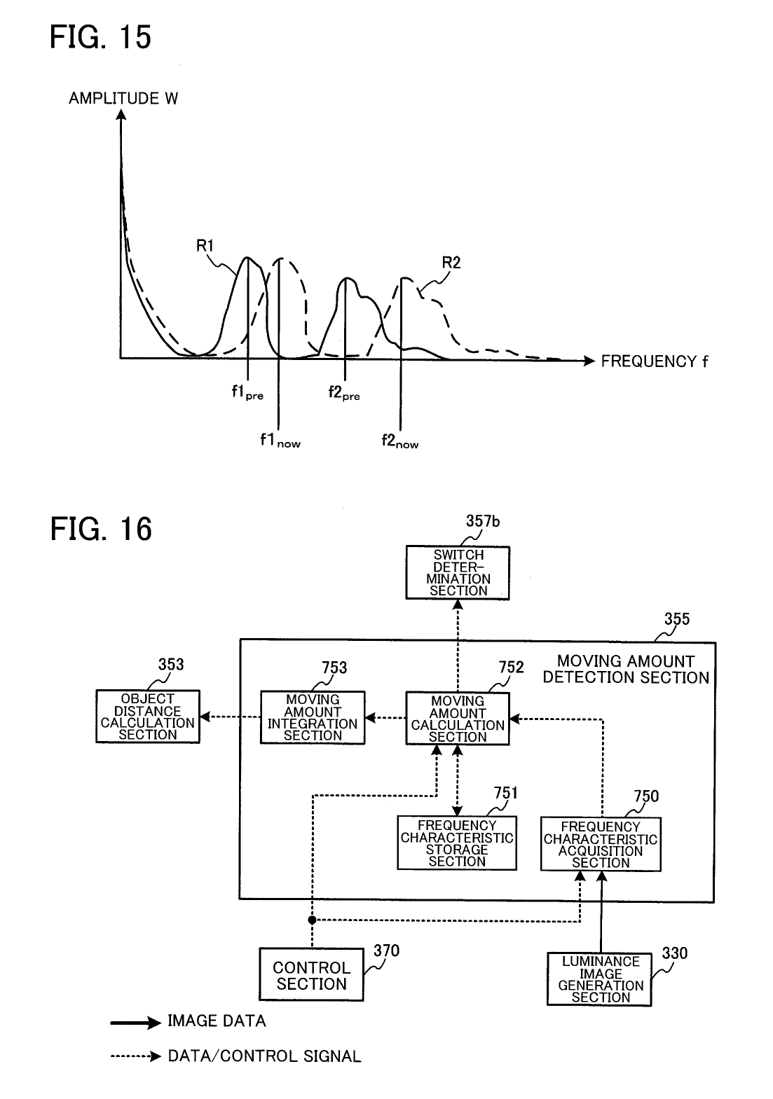

For example, frequency characteristics indicated by R1 in FIG. 15 are obtained by subjecting the luminance image shown in FIG. 13 to a frequency conversion process. An endoscope image is characterized in that blood vessels (see FIG. 13) have a high-frequency component. The frequency characteristics R1 have peaks at specific frequencies f1ₚᵣₑ and f2ₚᵣₑ due to the frequency characteristics of the blood vessels, for example. Note that the number of peaks is not limited to two. Note that the frequency characteristics R1 are obtained by subjecting the luminance signals along a dotted line indicated by P1 in FIG. 13 to a frequency conversion process.

Suppose that the distance between the end of the imaging section 200 and the object at a time t+1 is “A×D” (see FIG. 8). When A is a real number that is larger than 1, for example, the distance between the end of the imaging section 200 and the object is relatively longer than that at the time t.

In this case, an image shown in FIG. 14 is acquired by the luminance image generation section 330. As shown in FIG. 14, an area indicated by Z1 corresponds to the imaging area at the time t. In FIG. 14, the size of the blood vessels within the image is relatively smaller than that shown in FIG. 13. Therefore, frequency characteristics indicated by R1 in FIG. 15 are obtained by subjecting the luminance signals along a dotted line indicated by P2 in FIG. 14 to a frequency conversion process. Since the blood vessels have a high-frequency component, the frequency characteristics R2 also have peaks at specific frequencies f1_{now} and f2_{now}.

The frequencies f1ₚᵣₑ, f2ₚᵣₑ, f1_{now}, and f2_{now} and the relative moving amount A with respect to the time t satisfy the relationship shown by the following expression (13).

$$A = \frac{f {1}_{now}}{f {1}_{pre}} = \frac{f {2}_{now}}{f {2}_{pre}} \qquad ( 13 )$$

The expression (13) indicates that the frequency at the time t+1 is proportional to the frequency at the time t. When the proportionality coefficient is referred to as x, the frequency at the time t+1 is referred to as x×f, and the frequency characteristics R1 and R2 are respectively expressed by Wₚᵣₑ(f) and W_{now}(f), an value ε is calculated by the following expression (14). The value ε becomes a minimum when “x=A”. fmax is the Nyquist frequency. The second term “Wₚᵣₑ(0)/W_{now}(0)” of the expression (14) corresponds to a luminance signal normalization process.

$$ɛ = {\sum }_{f = 0}^{f max} {\{ {W}_{pre} ( f ) - \frac{{W}_{pre} ( 0 )}{{W}_{now} ( 0 )} {W}_{now} ( x \times f ) \}}^{2} \qquad ( 14 )$$

The moving amount A can be calculated by calculating the proportionality coefficient x at which the value ε (see the expression (14)) becomes a minimum. Since W_{now}(f) is a discrete value, W_{now}(x×f) in the expression (14) is calculated using the following expression (15). In the expression (15), W_{now}(f)=0 when f>fmax. fmax is the upper-limit value of the spatial frequency of an FFT process, for example. In the expression (15), int(V) indicates a process that acquires the integral part of the real number V, and a(V) indicates a process that acquires the fractional part of the real number V.

$${W}_{now} ( x \times f ) = \{ 1 - a ( x \times f ) \} \times {W}_{now} ( int ( x \times f ) ) + a ( x \times f ) \times {W}_{now} ( int ( x \times f ) + 1 ) \qquad ( 15 )$$

FIG. 16 shows a specific configuration example of the moving amount detection section 355. The moving amount detection section 355 includes a frequency characteristic acquisition section 750, a frequency characteristic storage section 751, a moving amount calculation section 752, and a moving amount integration section 753. The frequency characteristic acquisition section 750 is connected to the moving amount calculation section 752. The frequency characteristic storage section 751 is bidirectionally connected to the moving amount calculation section 752. The moving amount calculation section 752 is connected to the moving amount integration section 753. The frequency characteristic acquisition section 750 and the moving amount calculation section 752 are connected to the control section 370.

The frequency characteristic acquisition section 750 subjects the luminance image output from the luminance image generation section 330 to a frequency conversion process to acquire the frequency characteristics W_{now}(f). The frequency conversion process may be implemented by a known Fourier transform process, for example. The frequency characteristic acquisition section 750 subjects the luminance signals along the dotted line indicated by P1 in FIG. 13 to the frequency conversion process, for example.

The area of the luminance image used for the frequency conversion process is not limited to the above area, but may be arbitrarily set by the user via the external I/F section 500. A plurality of areas may be set other than P1. In this case, the average value of the frequency characteristics acquired from the plurality of areas may be used as the frequency characteristics W_{now}(f), for example.

The frequency characteristic acquisition section 750 outputs the frequency characteristics W_{now}(f) acquired by the above method to the moving amount calculation section 752.

The moving amount calculation section 752 calculates the inter-frame relative moving amount A′. The moving amount calculation section 752 calculates the inter-frame relative moving amount A′ using the frequency characteristics W_{now}(f) output from the frequency characteristic acquisition section 750, the frequency characteristics stored in the frequency characteristic storage section 751, and the expression (14). The frequency characteristics Wₚᵣₑ(f) of the luminance image in the preceding frame are stored in the frequency characteristic storage section 751 (described later).

The moving amount calculation section 752 sets the proportionality coefficient x at which the value ε (see the expression (14)) becomes a minimum to be the moving amount A′. Specifically, the moving amount calculation section 752 calculates the value ε (see the expression (14)) corresponding to each of (N+1) x values (see the following expression (16)), and determines the proportionality coefficient x at which the value ε becomes a minimum to be the moving amount A′. The minimum value ε is indicated by εₘᵢₙ. In the expression (16), n is an integer that satisfies the relationship “0≦n≦N”.

$$x = 1.0 + ( \frac{2 n}{N} - 1 ) \times dx \qquad ( 16 )$$

For example, when “dx=0.2” and “N=20”, the value ε (see the expression (14)) is calculated under twelve conditions at intervals of “0.02” (x=0.8 to 1.2). The values N and dx in the expression (16) may be constant values set in advance, or may be arbitrarily set by the user via the external I/F section 500.

The moving amount calculation section 752 outputs the calculated moving amount A′ to the moving amount integration section 753, and outputs the frequency characteristics W_{now}(f) output from the frequency characteristic acquisition section 750 to the frequency characteristic storage section 751. The frequency characteristic storage section 751 stores the frequency characteristics W_{now}(f) output from the moving amount calculation section 752 as the frequency characteristics Wₚᵣₑ(f). Therefore, the frequency characteristics acquired from the luminance image in the preceding frame are stored in the frequency characteristic storage section 751. The moving amount calculation section 752 outputs the minimum value εₘᵢₙ to the switch determination section 357b.

The moving amount calculation section 752 sets the moving amount A′ and the minimum value εₘᵢₙ to “1” and “0”, respectively, in the initial frame.

The moving amount integration section 753 integrates the inter-frame relative moving amount A′ output from the moving amount calculation section 752 to calculate a relative moving amount Aₐₗₗ with respect to the initial frame. Specifically, the moving amount integration section 753 updates the moving amount Aₐₗₗ using the following expression (17) to calculate the relative moving amount Aₐₗₗ with respect to the initial frame. The initial value of the moving amount Aₐₗₗ is set to “1”.

Aₐₗₗ=Aₐₗₗ×A′ (17)

The switch determination section 357b switches the focusing process from the second focusing process to the first focusing process. Specifically, the switch determination section 357b determines whether or not to switch the focusing process based on the contrast value, the elapsed time, and the moving amount calculation accuracy.

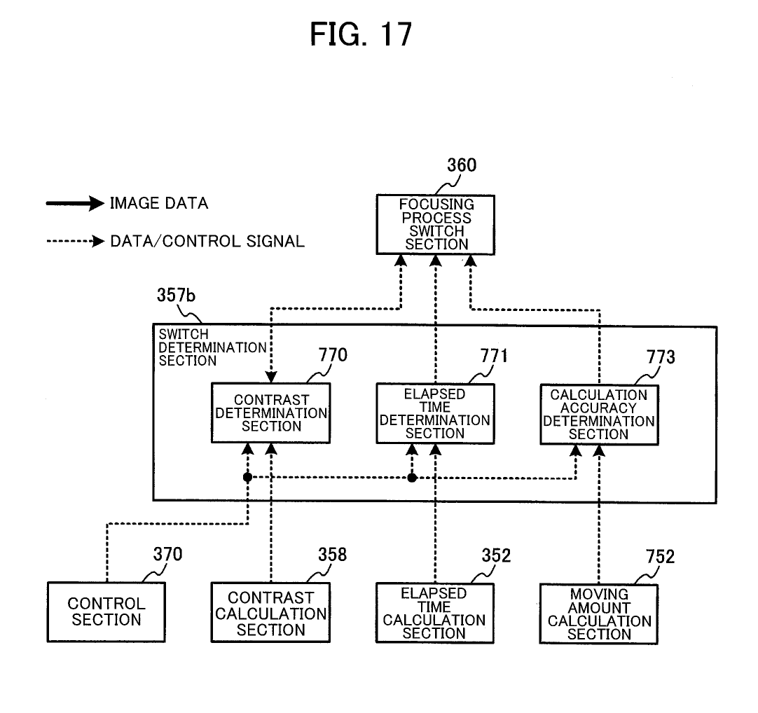

FIG. 17 shows a specific configuration example of the switch determination section 357b. The switch determination section 357b includes a contrast determination section 770, an elapsed time determination section 771, and a calculation accuracy determination section 773. The processes performed by the contrast determination section 770 and the elapsed time determination section 771 are the same as those described above in connection with the first embodiment. Therefore, description thereof is appropriately omitted. The calculation accuracy determination section 773 is connected to the control section 370.

The calculation accuracy determination section 773 performs a determination process using a threshold value ε_{TH} on the minimum value εₘᵢₙ output from the moving amount calculation section 752. The minimum value εₘᵢₙ is an evaluation value that indicates the degree of coincidence between the frequency characteristics W_{now}(A′×f) and Wₚᵣₑ(f) (see the expression (14)). It is expected that the accuracy of the calculated moving amount A′ is low when the minimum value εₘᵢₗ is large.

Therefore, the calculation accuracy determination section 773 determines that the calculation accuracy of the moving amount A′ is low when the condition “εₘᵢₙ>ε_{TH}” is satisfied. In this case, the calculation accuracy determination section 773 outputs the trigger signal that indicates that the focusing process should be switched to the focusing process switch section 360.

According to the second embodiment, it is possible to quickly control the focus while detecting the object distance with high accuracy. This makes it unnecessary for the doctor to manually adjust the focus, so that the burden on the doctor can be reduced. Moreover, since a high-contrast image can be necessarily provided, a situation in which the lesion is missed can be prevented.

According to the second embodiment, since the moving amount is detected based on the frequency component of the luminance image, the detection process is not affected by a temporal change in the intensity of light emitted from the light source section 100. In the first embodiment (see FIG. 1, for example), the moving amount is detected based on the average luminance of the luminance image calculated using the expression (8). Therefore, the average luminance may change due to a temporal change in the intensity of light emitted from the light source section 100. According to the second embodiment, the moving amount estimation accuracy does not deteriorate, and the object distance can be stably detected even if the intensity of light emitted from the light source section 100 changes.

As shown in FIG. 16, the second focusing section 350 includes the frequency characteristic acquisition section 750 that acquires the frequency characteristics Wₚᵣₑ(f) and W_{now}(f) of the acquired images. The moving amount detection section 355 detects the moving amount Aₐₗₗ based on the frequency characteristics Wₚᵣₑ(f) and W_{now}(f).

Specifically, the endoscope system includes the imaging section 200 that acquires images in time series. The imaging section 200 acquires the first image and the second image in time series. The moving amount detection section 355 performs a frequency axis (f) scale conversion process (x×f) on the frequency characteristics W_{now}(f) of the second image, performs a matching process on the frequency characteristics Wₚᵣₑ(f) of the first image and the frequency characteristics W_{now}(x×f) of the second image while changing the scale conversion factor x, and detects the moving amount Aₐₗₗ based on the conversion factor x at which the error value ε that indicates a matching error becomes a minimum (see the expression (14)). More specifically, the moving amount detection section 355 determines the conversion factor x at which the error value ε becomes a minimum to be the inter-frame moving amount A′, and integrates the moving amount A′ to calculate the moving amount Aₐₗₗ.

This makes it possible to detect the relative moving amount of the imaging section and the object based on the frequency characteristics of the image. Specifically, the moving amount can be detected by utilizing the fact that the size of the object within the image changes when the distance between the imaging section and the object has changed, and the scale of the frequency characteristics in the direction of the frequency axis changes.

Note that the moving amount may be detected using motion information (e.g., motion vector (described later) instead of the frequency characteristics. The term “motion information” used herein refers to information that indicates the motion of the object within the image due to a change in the distance between the imaging section and the object.

As shown in FIG. 12, the second focusing section 350 includes the switch determination section 357b that determines whether or not to switch the focusing process based on the parameter for evaluating the in-focus state during the second focusing process. The switch determination section 357b determines whether or not to switch the focusing process based on the frequency characteristics Wₚᵣₑ(f) and W_{now}(f).

Specifically, the second focusing section 350 performs the matching process on the frequency characteristics Wₚᵣₑ(f) of the first image and the frequency characteristics W_{now}(f) of the second image, and performs the second focusing process based on the error value ε that indicates a matching error. The switch determination section 357b switches the focusing process from the second focusing process to the first focusing process when the error value εₘᵢₙ (the minimum value of the error value ε when changing the conversion factor x) (i.e., parameter) is larger than the threshold value ε_{TH}.

This makes it possible to switch the focusing process from the second focusing process to the first focusing process based on the frequency characteristics. Since the focusing process is switched when the matching process error value has exceeded the threshold value, it is possible to switch the focusing process to the first focusing process, and reliably recover the in-focus state when it is likely that the accuracy of the matching process has deteriorated, and the moving amount is not accurately estimated.

### 4. Third Embodiment

The first embodiment has been described taking an example in which the relative moving amount with respect to the initial frame is detected using the expression (6) based on the average luminance of the luminance image. In a third embodiment, the moving amount may be detected based on a motion vector (motion information in a broad sense) detected from a local area of the luminance image.

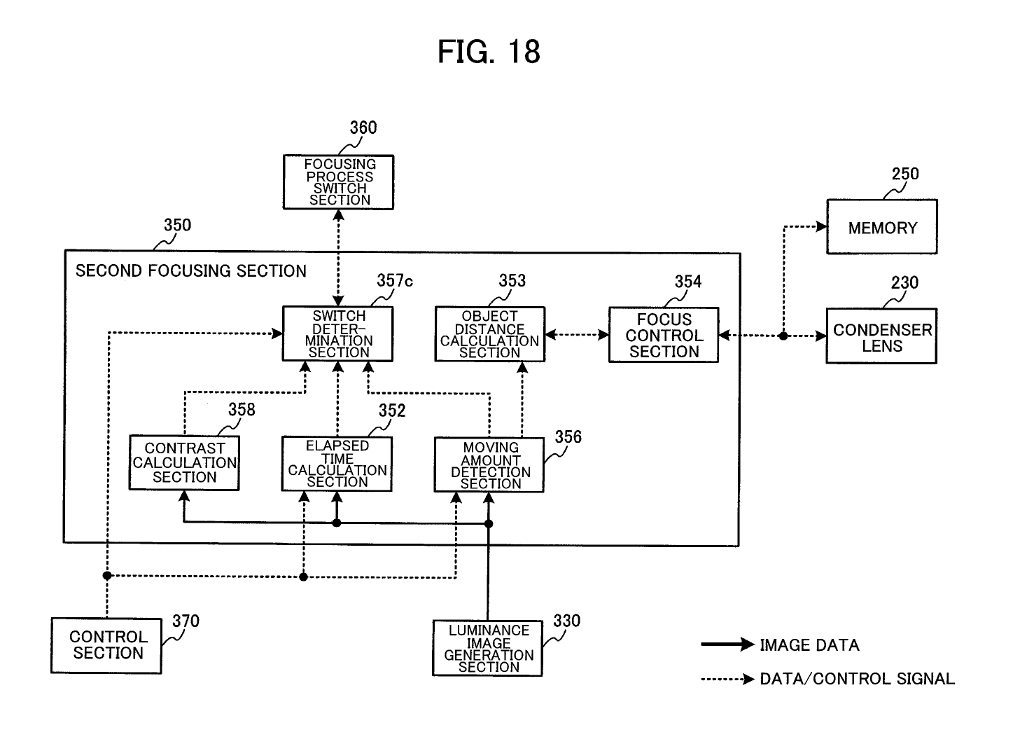

FIG. 18 shows a third specific configuration example of the second focusing section 350. The second focusing section 350 includes a moving amount detection section 356, an elapsed time calculation section 352, an object distance calculation section 353, a focus control section 354, a contrast calculation section 358, and a switch determination section 357c. Note that the basic configuration of the endoscope system is the same as that described above in connection with the first embodiment, and the processes other than the process performed by the second focusing section 350 are the same as those described above in connection with the first embodiment. Description of the same configuration and the same processes as those described above in connection with the first embodiment are appropriately omitted. The processes other than the processes performed by the moving amount detection section 356 and the switch determination section 357c are the same as those described above in connection with the first embodiment. Description of the same processes as those described above in connection with the first embodiment are appropriately omitted.

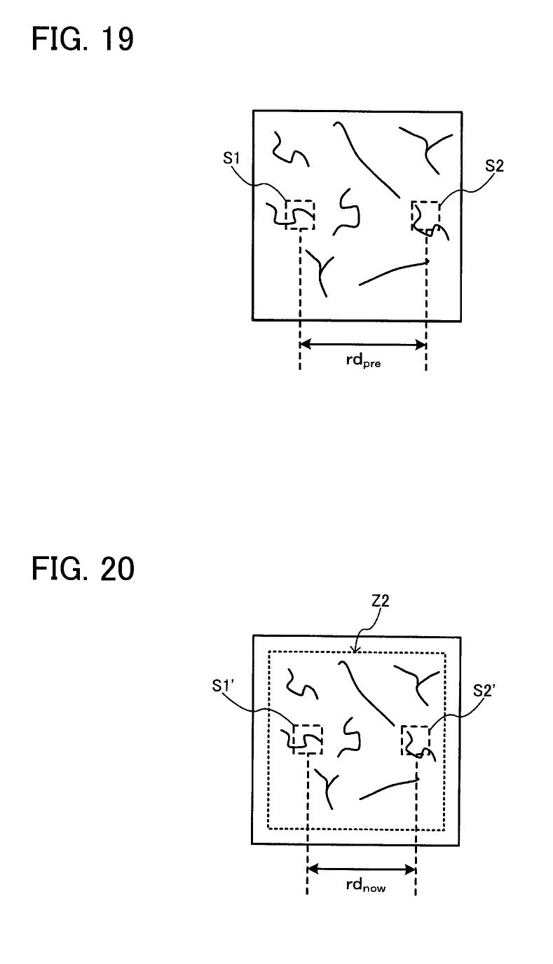

The relationship between the motion vector and the moving amount is described below. Suppose that an image shown in FIG. 19 has been acquired by the luminance image generation section 330 when the distance between the end of the imaging section 200 and the object at a time t is D (see FIG. 7).

Suppose that the distance between the end of the imaging section 200 and the object has increased to “A×D” at the time t+1 (see FIG. 8). When A is a real number that is larger than 1, for example, the distance between the end of the imaging section 200 and the object is relatively longer than that at the time t. Therefore, an image shown in FIG. 20 is acquired by the luminance image generation section 330. In FIG. 20, an area indicated by Z2 corresponds to the imaging area at the time t.

Local areas S1 and S2 are set within the image shown in FIG. 19. The local areas S1 and S2 respectively correspond to local areas S1′ and S2′ within the image shown in FIG. 20. The above relationship is calculated using a known block matching process, for example.

The center coordinates of the local area S1 and the center coordinates of the local area S2 are respectively referred to as (x1, y1) and (x2, y2), and the center coordinates of the local area S1′ and the center coordinates of the local area S2′ are respectively referred to as (x1′, y1′) and (x2′, y2′). These coordinates and the relative moving amount A with respect to the time t satisfy the relationship shown by the following expression (18). Note that rdₚᵣₑ is the distance between the center coordinates of the local area S1 and the center coordinates of the local area S2, and rd_{now} is the distance between the center coordinates of the local area S1′ and the center coordinates of the local area S2′.

$$A = \frac{{rd}_{pre}}{{rd}_{now}} = \frac{\sqrt{{( x 2 - x 1 )}^{2} + {( y 2 - y 1 )}^{2}}}{\sqrt{{( x {2}^{′} - x {1}^{′} )}^{2} + {( y {2}^{′} - y {1}^{′} )}^{2}}} \qquad ( 18 )$$

The relative moving amount A can thus be calculated using the expression (18).

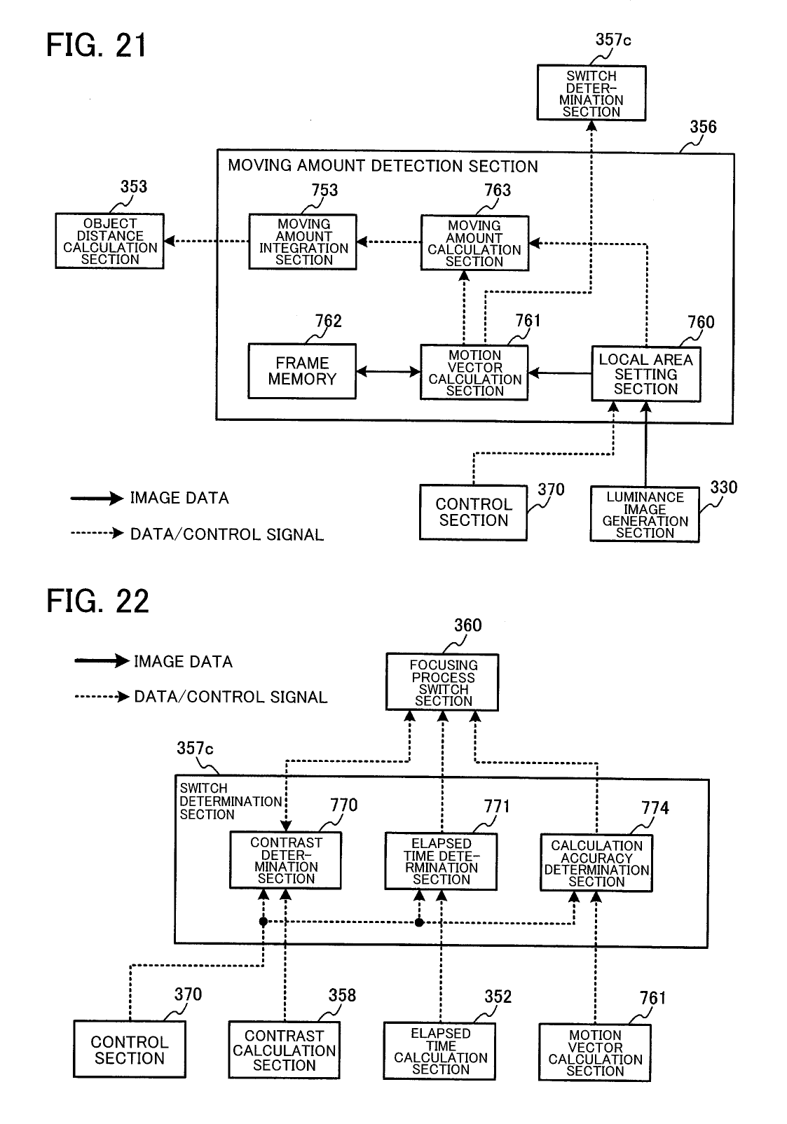

The moving amount detection section 356 detects the relative moving amount of the imaging section and the object based on a change in the distance between the local areas set within the image. FIG. 21 shows a specific configuration example of the moving amount detection section 356. The moving amount detection section 356 includes a local area setting section 760, a motion vector calculation section 761, a frame memory 762, a moving amount calculation section 763, and a moving amount integration section 753. The local area setting section 760 is connected to the moving amount calculation section 763 and the motion vector calculation section 761. The frame memory 762 is bidirectionally connected to the motion vector calculation section 761. The moving amount calculation section 763 is connected to the motion vector calculation section 761 and the moving amount integration section 753.

The local area setting section 760 sets the local areas S1 and S2 shown in FIG. 19 within the luminance image output from the luminance image generation section 330. The center coordinates of the local area S1 and the center coordinates of the local area S2 are respectively referred to as (x1, y1) and (x2, y2). The local area setting section 760 outputs the luminance image and information about the local areas set within the luminance image to the motion vector calculation section 761. The information about the local area includes the center coordinates and the size of the local area. The local area setting section 760 outputs the center coordinates of the local areas set as described above to the moving amount calculation section 763.

Note that the number of local areas set within the image is not limited two. It suffices that a plurality of local areas be set within the image. The coordinates and the size of the local area may be constant values set in advance, or may be arbitrarily set by the user via the external I/F section 500.

The motion vector calculation section 761 calculates the motion vectors of the local areas by a known block matching process or the like using the luminance image output from the local area setting section 760 and the luminance image stored in the frame memory 762. The motion vector of the local area S1 and the motion vector of the local area S2 are respectively referred to as (dx1, dy1) and (dx2, dy2). The luminance image in the preceding frame is stored in the frame memory 762 (described later).

The block matching process searches the position of a block within the target image having a high correlation with an arbitrary block within a reference image. The inter-block relative difference corresponds to the motion vector of the block. In the third embodiment, the luminance image output from the local area setting section 760 corresponds to the reference image, and the luminance image stored in the frame memory 762 corresponds to the target image.

A block having a high correlation may be searched by the block matching process using an absolute error SAD, for example. Specifically, a block area within the reference image is referred to as B, a block area within the target image is referred to as B′, and the position of a block area B′ having a high correlation with a block area B is calculated. When the pixel position in the block area B and the pixel position in the block area B′ are respectively referred to as pεB and qεB′, and the signal values of the pixels are respectively referred to as Lp and Lq, the absolute error SAD is given by the following expression (19). It is determined that the correlation value is high when the value given by the expression (19) is small.

$$SAD ( B , {B}^{′} ) = {\sum }_{p ∈ B , q ∈ {B}^{′}} \vert Lp - Lq \vert \qquad ( 19 )$$

In the expression (19), the values p and q are two-dimensional values, the block areas B and B′ are two-dimensional areas, the pixel position pεB indicates that the coordinates p are included in the area B, and the pixel position pεB′ indicates that the coordinates q are included in the area B′. The block matching process outputs the inter-block relative difference when the absolute error SAD (see the expression (19)) becomes a minimum as the motion vector. The minimum absolute error in the local area S1 and the minimum absolute error in the local area S2 are respectively referred to as SAD1ₘᵢₙ, SAD2ₘᵢₙ.

The motion vector calculation section 761 outputs the calculated motion vectors (dx1, dy1) and (dx2, dy2) to the moving amount calculation section 763. The motion vector calculation section 761 outputs the luminance image output from the local area setting section 760 to the frame memory 762. Therefore, the image stored in the frame memory 762 is used in the subsequent frame as the luminance image in the preceding frame. The motion vector calculation section 761 outputs the minimum evaluation value among the minimum absolute errors SAD1ₘᵢₙ and SAD2ₘᵢₙ to the calculation accuracy determination section 774 as SADₘᵢₙ.

Note that the motion vector cannot be calculated in the initial frame since an image is not stored in the frame memory. Therefore, the motion vector calculation section 761 sets the magnitude of each motion vector and the value SADₘᵢₙ to “0” in the initial frame.

The moving amount calculation section 763 calculates the inter-frame relative moving amount A′ using the center coordinates (x1, y1) and (x2, y2) of the local areas output from the local area setting section 760, the motion vectors (dx1, dy1) and (dx2, dy2) output from the motion vector calculation section 761, and the expression (18). The center coordinates (x1′, y1′) and (x2′, y2′) (see the expression (18)) are calculated using the following expression (20).

x1′=x1+dx1

y1′=y1+dy1

x2′=x2+dx2

y2′=y2+dy2 (20)

The moving amount calculation section 763 outputs the calculated inter-frame relative moving amount A′ to the moving amount integration section 753. The moving amount integration section 753 integrates the moving amount A′ by the process described in connection with the second embodiment to calculate the integrated moving amount Aₐₗₗ with respect to the initial frame.

The switch determination section 357c switches the focusing process from the second focusing process to the first focusing process. Specifically, the switch determination section 357c determines whether or not to switch the focusing process based on the contrast value, the elapsed time, and the motion vector calculation accuracy.

FIG. 22 shows a specific configuration example of the switch determination section 357c. The switch determination section 357c includes a contrast determination section 770, an elapsed time determination section 771, and a calculation accuracy determination section 774. The processes performed by the contrast determination section 770 and the elapsed time determination section 771 are the same as those described above in connection with the first embodiment. Therefore, description thereof is appropriately omitted. The calculation accuracy determination section 774 is connected to the control section 370.

The calculation accuracy determination section 774 performs a determination process using a threshold value SAD_{TH} on the value SADₘᵢₙ output from the motion vector calculation section 761. The value SADₘᵢₙ corresponds to an evaluation value that indicates the degree of inter-block correlation. Therefore, the inter-block correlation is low, and the accuracy of the calculated motion vector is low when the evaluation value is small.

In the third embodiment, the inter-frame relative moving amount A′ is calculated using the motion vectors calculated by the motion vector calculation section 761 and the expression (18). This means that the accuracy of the moving amount A′ is determined by the motion vector calculation accuracy.

Therefore, the calculation accuracy determination section 774 performs the determination process using the threshold value SAD_{TH} on the value SADₘᵢₙ. Specifically, the calculation accuracy determination section 774 determines that the motion vector calculation accuracy is low when the condition “SADₘᵢₙ>SAD_{TH}” is satisfied. In this case, the calculation accuracy determination section 774 outputs the trigger signal that indicates that the focusing process should be switched to the focusing process switch section 360.

The threshold value SAD_{TH} may be a constant value set in advance, or may be arbitrarily set by the user via the external I/F section 500.

When the distance between the imaging section 200 and the object changes as shown in FIG. 8, the size of the object within the image normally changes. For example, when the object is a blood vessel, the thickness and the length of the blood vessel within the image change. Therefore, when the distance between the imaging section 200 and the object changes to a large extent, it is difficult to calculate the motion vector by performing the block matching process on the image in the initial frame and the image in the current frame.

However, since the frame rate of the imaging section 200 is about 30 fps, an inter-frame change in the distance between the imaging section 200 and the object is small.

In the third embodiment, the inter-frame relative moving amount A′ is calculated from the motion vectors detected between the frames, and the moving amount A′ is integrated using the expression (17) to detect the relative moving amount Aₐₗₗ with respect to the initial frame. According to the third embodiment, since the inter-frame moving amount A′ is integrated, the moving amount Aₐₗₗ can be detected even if the distance between the imaging section 200 and the object changes to a large extent.

It is possible to quickly control the focus while detecting the object distance with high accuracy by utilizing the above method. This makes it unnecessary for the doctor to manually adjust the focus, so that the burden on the doctor can be reduced. Moreover, since a high-contrast image can be necessarily provided, a situation in which the lesion is missed can be prevented.

Although an example in which the moving amount is calculated based on the motion vectors of the local areas has been described above, another configuration may also be employed. Specifically, it suffices that motion information that makes it possible to calculate an inter-frame change in the distance between the local areas be acquired, and the moving amount be calculated based on the motion information.

According to the third embodiment, the second focusing section 350 includes a motion vector detection section that detects the motion vectors (dx1, dy1) and (dx2, dy2) from the acquired image (see FIG. 21). The moving amount detection section 356 detects the moving amount Aₐₗₗ based on the detected motion vectors (dx1, dy1) and (dx2, dy2). In the third embodiment, the motion vector calculation section 761 corresponds to the motion vector detection section.

Specifically, the imaging section 200 acquires the first image and the second image in time series. The second focusing section 350 performs the matching process on the first image and the second image to detect the motion vectors (dx1, dy1) and (dx2, dy2) of the local areas S1 and S2, calculates a change rdₚᵣₑ/rd_{now} in the distance between the local areas S1 and S2 based on the motion vectors, calculates the inter-frame moving amount A′ based on the change in the distance, and integrates the moving amount A′ to calculate the moving amount Aₐₗₗ.

This makes it possible to detect the relative moving amount of the imaging section and the object based on the motion vectors. Specifically, the moving amount can be detected by utilizing the fact that the distance between the objects within the image changes when the distance between the imaging section and the object has changed.

As shown in FIG. 18, the second focusing section 350 includes the switch determination section 357c that determines whether or not to switch the focusing process based on the parameter for evaluating the in-focus state during the second focusing process. The motion vector detection section calculates the error value SADₘᵢₙ that indicates a matching error of the matching process. The switch determination section 357c determines whether or not to switch the focusing process using the error value SADₘᵢₙ as a parameter.

More specifically, the switch determination section 357c determines to switch the focusing process to the first focusing process when the error value SADₘᵢₙ that is the minimum matching error value is larger than the threshold value SAD_{TH}.

This makes it possible to switch the focusing process from the second focusing process to the first focusing process based on the motion vector matching error. Since the focusing process is switched when the error value has exceeded the threshold value, it is possible to switch the focusing process to the first focusing process, and reliably recover the in-focus state when it is likely that the accuracy of the matching process has deteriorated, and the moving amount is not accurately estimated.

### 5. Software

Although an example in which each section of the control device 300 is implemented by hardware has been described above, another configuration may also be employed. For example, a CPU may perform the process of each section on an image acquired by the imaging section. Specifically, the process of each section may be implemented by means of software by causing the CPU to execute a program. Alternatively, part of the process of each section may be implemented by means of software.

When separately providing the imaging section, and implementing the process of each section of the control device 300 by means of software, a known computer system (e.g., work station or personal computer) may be used as a control device. A program (control program) that implements the process of each section of the control device 300 may be provided in advance, and executed by the CPU of the computer system.

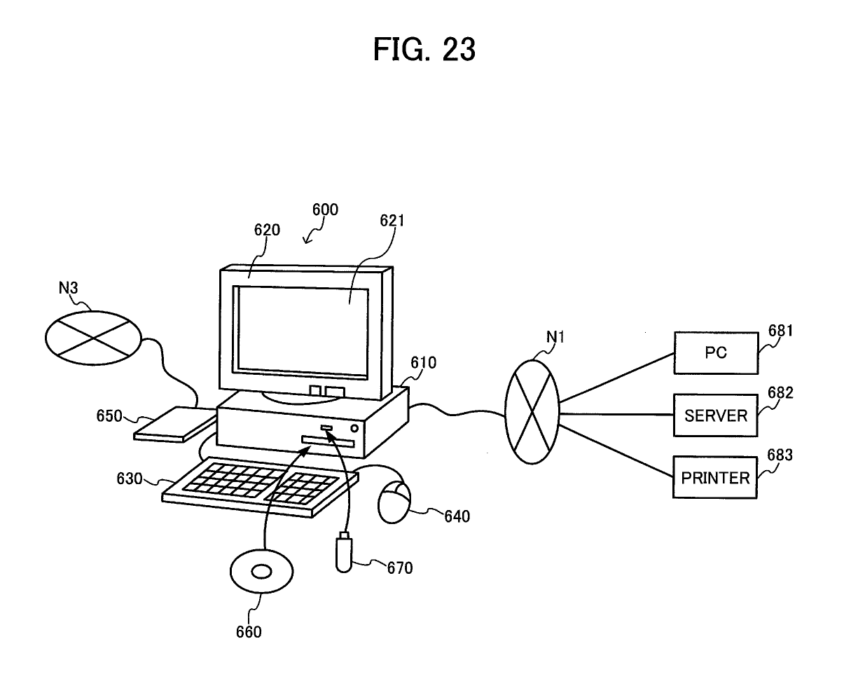

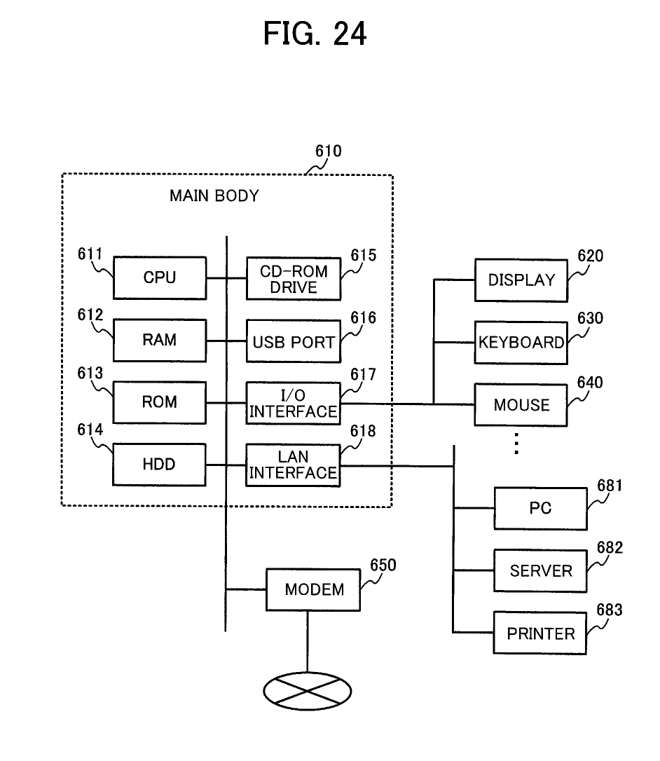

FIG. 23 is a system configuration diagram showing the configuration of a computer system 600 according to a modification. FIG. 24 is a block diagram showing the configuration of a main body 610 of the computer system 600. As shown in FIG. 23, the computer system 600 includes the main body 610, a display 620 that displays information (e.g., image) on a display screen 621 based on instructions from the main body 610, a keyboard 630 that allows the user to input information to the computer system 600, and a mouse 640 that allows the user to designate an arbitrary position on the display screen 621 of the display 620.

As shown in FIG. 24, the main body 610 of the computer system 600 includes a CPU 611, a RAM 612, a ROM 613, a hard disk drive (HDD) 614, a CD-ROM drive 615 that receives a CD-ROM 660, a USB port 616 to which a USB memory 670 is removably connected, an I/O interface 617 that connects the display 620, the keyboard 630, and the mouse 640, and a LAN interface 618 that is used to connect to a local area network or a wide area network (LAN/WAN) N1.

The computer system 600 is connected to a modem 650 that is used to connect to a public line N3 (e.g., Internet). The computer system 600 is also connected to a personal computer (PC) 681 (i.e., another computer system), a server 682, a printer 683, and the like via the LAN interface 618 and the local area network or the large area network N1.

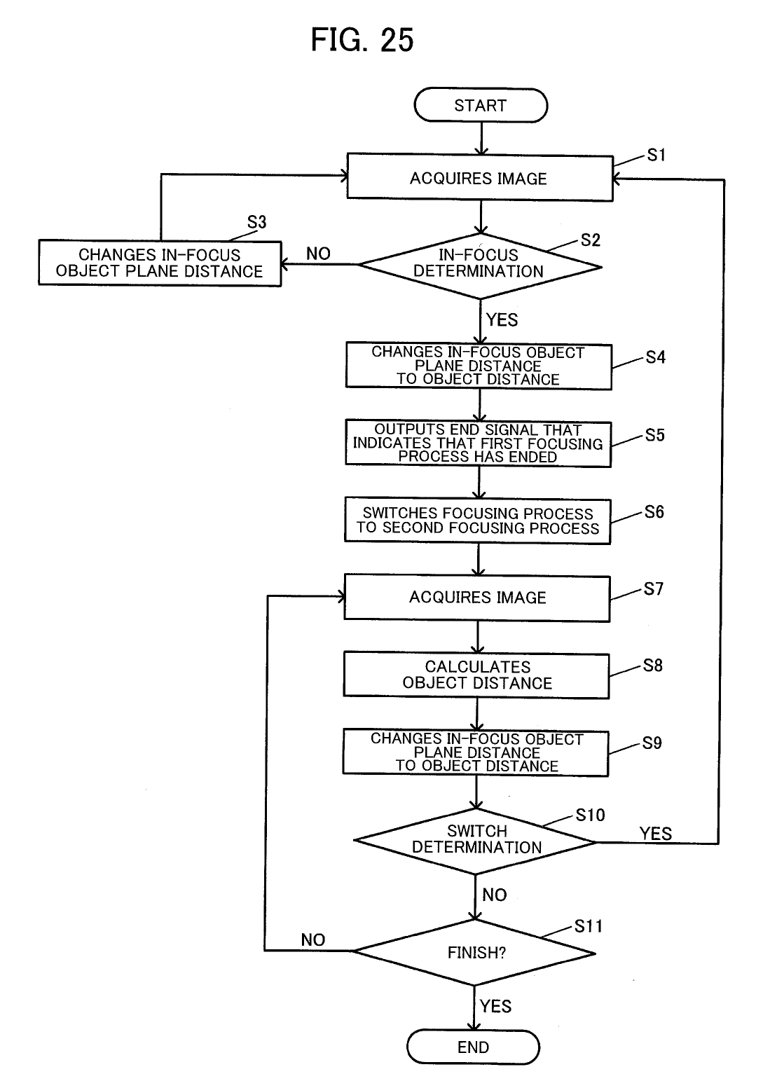

The computer system 600 implements the functions of the control device by reading a control program (e.g., a control program that implements a process described later referring to FIG. 25) recorded on a given recording medium, and executing the control program. The given recording medium may be an arbitrary recording medium that records the control program that can be read by the computer system 600, such as the CD-ROM 660, the USB memory 670, a portable physical medium (e.g., MO disk, DVD disk, flexible disk (FD), magnetooptical disk, or IC card), a stationary physical medium (e.g., HDD 614, RAM 612, or ROM 613) that is provided inside or outside the computer system 600, or a communication medium that temporarily stores a program during transmission (e.g., the public line N3 connected via the modem 650, or the local area network or the wide area network N1 to which the computer system (PC) 681 or the server 682 is connected).

Specifically, the control program is recorded on a recording medium (e.g., portable physical medium, stationary physical medium, or communication medium) so that the image processing program can be read by a computer. The computer system 600 implements the functions of the control device by reading the control program from such a recording medium, and executing the control program. Note that the control program need not necessarily be executed by the computer system 600. The invention may be similarly applied to the case where the computer system (PC) 681 or the server 682 executes the control program, or the computer system (PC) 681 and the server 682 execute the control program in cooperation.

A process performed when implementing the process of the control device 300 on an image acquired by the imaging section by means of software is described below using a flowchart shown in FIG. 25 as an example of implementing part of the process of each section by means of software.

As shown in FIG. 25, an image is captured (S1), and whether or not the object distance has been determined by the first focusing process is determined (S2). When it has been determined that the object distance has not been determined (S2, No), the in-focus object plane distance of the optical system is changed (moved) (S3), and an image is captured (S1). When it has been determined that the object distance has been determined (S2, Yes), the in-focus object plane distance of the optical system is changed (moved) to the object distance (S4). An end signal that indicates that the first focusing process has ended is output (S5), and the focusing process is switched to the second focusing process (S6).

When the focusing process has been switched to the second focusing process, an image is captured (S7), and the moving amount is estimated to calculate the object distance (S8). The in-focus object plane distance of the optical system is changed (moved) to the object distance (S9), and whether or not to switch the focusing process to the first focusing process is determined (S10). When it has been determined to switch the focusing process to the first focusing process (S10, Yes), the focusing process is switched to the first focusing process (S1). When it has been determined not to switch the focusing process to the first focusing process (S10, No), whether or not to finish the imaging process is determined (S11). When it has been determined to continue the imaging process (S11, No), an image is acquired, and the second focusing process is performed (S7). When it has been determined to finish the imaging process (S11, Yes), the process is terminated.

This makes it possible to capture (acquire) image data using the separate imaging section, and process the image data by means of software using a computer system (e.g., PC), for example.

The above embodiments may be also be applied to a computer program product that stores a program code that implements each section (e.g., first focusing section, second focusing section, focusing process switch section, and luminance image generation section) described in connection with the above embodiments.

The program code implements a first focusing section that performs is a first focusing process, a second focusing section that performs a second focusing process, and a focusing process switch section that switches the focusing process between the first focusing process and the second focusing process. The first focusing section includes an in-focus determination section that determines whether or not the first focusing process has been accomplished. The focusing process switch section switches the focusing process to the second focusing process when the in-focus determination section has determined that the first focusing process has been accomplished.

The term “computer program product” refers to an information storage medium, a device, an instrument, a system, or the like that stores a program code, such as an information storage medium (e.g., optical disk medium (e.g., DVD), hard disk medium, and memory medium) that stores a program code, a computer that stores a program code, or an Internet system (e.g., a system including a server and a client terminal), for example. In this case, each element and each process described in connection with the above embodiments are implemented by corresponding modules, and a program code that includes these modules is recorded in the computer program product.

The embodiments according to the invention and modifications thereof have been described above. Note that the invention is not limited to the above embodiments and modifications thereof. Various modifications and variations may be made without departing from the scope of the invention. A plurality of elements disclosed in connection with the above embodiments and modifications thereof may be appropriately combined. For example, some of the elements disclosed in connection with the above embodiments and modifications thereof may be omitted. Some of the elements disclosed in connection with different embodiments or modifications thereof may be appropriately combined. Specifically, various modifications and applications are possible without materially departing from the novel teachings and advantages of the invention.

Any term (e.g., endoscope apparatus or contrast AF process) cited with a different term (e.g., endoscope system or first focusing process) having a broader meaning or the same meaning at least once in the specification and the drawings may be replaced by the different term in any place in the specification and the drawings.

What is claimed is:

1. An imaging apparatus comprising:
an optical system;
a first focusing section that controls a focus of the optical system, and performs a first focusing process based on a first evaluation value;
a second focusing section that controls the focus of the optical system, and performs a second focusing process based on a second evaluation value; and
a focusing process switch section that switches a focusing process between the first focusing process and the second focusing process,
the first focusing section including an in-focus determination section that determines whether or not the first focusing process has been accomplished, and
the focusing process switch section switching the focusing process from the first focusing process to the second focusing process when the in-focus determination section has determined that the first focusing process has been accomplished.

2. The imaging apparatus as defined in claim 1, further comprising:
an imaging section that acquires images in time series,
the focusing process switch section allowing the first focusing section to continue the first focusing process until it is determined that the first focusing process has been accomplished, and
the focusing process switch section switching the focusing process performed on a subsequently-acquired image to the second focusing process performed by the second focusing section when it has been determined that the first focusing process has been accomplished.

3. The imaging apparatus as defined in claim 2,
the imaging section acquiring images in time series using a plurality of in-focus object plane distances,
the first focusing section calculating contrast values of the images acquired in time series using the plurality of in-focus object plane distances as the first evaluation value, and performing the first focusing process based on the calculated contrast values to control the focus of the optical system,
the second focusing section performing the second focusing process on each of images acquired in time series after the focusing process has been switched to the second focusing process, and
the second focusing section detecting a relative moving amount of the imaging section and an object as the second evaluation value, and controlling the focus of the optical system based on the detected moving amount.

4. The imaging apparatus as defined in claim 1,
the second focusing section including a switch determination section that determines whether or not to switch the focusing process based on a parameter for evaluating a focus state during the second focusing process, and
the focusing process switch section switching the focusing process from the second focusing process to the first focusing process based on a determination result of the switch determination section.

5. The imaging apparatus as defined in claim 4,
the parameter being a control parameter that is used during the second focusing process.

6. The imaging apparatus as defined in claim 4,
the second focusing section including a contrast calculation section that calculates a contrast value based on an acquired image, and
the switch determination section determining whether or not to switch the focusing process using the contrast value as the parameter.

7. The imaging apparatus as defined in claim 4,
the second focusing section including an average luminance calculation section that calculates an average luminance of an acquired image, and
the switch determination section determining whether or not to switch the focusing process using the average luminance as the parameter.

8. The imaging apparatus as defined in claim 4,
the second focusing section including a frequency characteristic acquisition section that acquires frequency characteristics of an acquired image, and
the switch determination section determining whether or not to switch the focusing process based on the frequency characteristics.

9. The imaging apparatus as defined in claim 8, further comprising:
an imaging section that acquires images in time series,
the imaging section acquiring a first image and a second image as the images,
the second focusing section performing a matching process on frequency characteristics of the first image and frequency characteristics of the second image, and performing the second focusing process based on an error value that indicates a matching error, and
the switch determination section determining to switch the focusing process from the second focusing process to the first focusing process when the error value as the parameter is larger than a threshold value.

10. The imaging apparatus as defined in claim 4, further comprising:
an imaging section that acquires images in time series,
the imaging section acquiring a first image and a second image as the images,
the second focusing section including a motion vector detection section that performs a matching process on the first image and the second image to detect a motion vector of an object,
the motion vector detection section calculating an error value that indicates a matching error of the matching process, and
the switch determination section determining whether or not to switch the focusing process using the error value as the parameter.

11. The imaging apparatus as defined in claim 4,
the second focusing section including an elapsed time calculation section that measures an elapsed time after the focusing process switch section has switched the focusing process to the second focusing process, and
the switch determination section determining whether or not to switch the focusing process using the elapsed time as the parameter.

12. The imaging apparatus as defined in claim 1,
the second focusing section including a moving amount detection section that detects a relative moving amount of an imaging section and an object as the second evaluation value, and
the second focusing section controlling the focus of the optical system based on the moving amount.

13. The imaging apparatus as defined in claim 12,
the moving amount detection section detecting the moving amount based on a temporal change in an image signal of an image acquired by the imaging section.

14. The imaging apparatus as defined in claim 13, further comprising:
an imaging section that acquires images in time series,
the imaging section acquiring a first image and a second image as the images, and
the moving amount detection section detecting the moving amount using a ratio of an average luminance value of the first image to an average luminance value of the second image as a temporal change in the image signal.

15. The imaging apparatus as defined in claim 12,
the second focusing section including a frequency characteristic acquisition section that acquires frequency characteristics of an image acquired by the imaging section, and
the moving amount detection section detecting the moving amount based on the frequency characteristics.

16. The imaging apparatus as defined in claim 15, further comprising:
an imaging section that acquires images in time series,
the imaging section acquiring a first image and a second image as the images, and
the moving amount detection section performing a frequency axis scale conversion process on frequency characteristics of the second image, performing a matching process on frequency characteristics of the first image and the frequency characteristics of the second image while changing a conversion factor of the frequency axis scale conversion process, and detecting the moving amount based on the conversion factor at which an error value that indicates a matching error becomes a minimum.

17. The imaging apparatus as defined in claim 12,
the second focusing section including a motion vector detection section that acquires a motion vector from an image acquired by the imaging section, and
the moving amount detection section detecting the moving amount based on the detected motion vector.

18. The imaging apparatus as defined in claim 1,
the optical system changing the focus by selecting one in-focus object plane distance among a given plurality of in-focus object plane distances.

19. The imaging apparatus as defined in claim 1,
the optical system performing a zoom process,
the first focusing section performing the first focusing process in a magnifying observation mode in which a magnification of the zoom process is set to be higher than that employed in a normal observation mode, and
the second focusing section performing the second focusing process in the magnifying observation mode.

20. The imaging apparatus as defined in claim 1,
the imaging apparatus acquiring images in time series.

21. The imaging apparatus as defined in claim 12,
the second focusing section not changing the focus of the optical system when the moving amount is smaller than a threshold value.

22. The imaging apparatus as defined in claim 1,
the first focusing section including a contrast calculation section that calculates a contrast value from an acquired image as the first evaluation value, and performing the first focusing process based on the calculated contrast value to control the focus of the optical system.

23. An information storage medium storing a program that causes a computer to function as:
a first focusing section that controls a focus of an optical system, and performs a first focusing process based on a first evaluation value;
a second focusing section that controls the focus of the optical system, and performs a second focusing process based on a second evaluation value; and
a focusing process switch section that switches a focusing process between the first focusing process and the second focusing process,
the first focusing section including an in-focus determination section that determines whether or not the first focusing process has been accomplished, and
the focusing process switch section switching the focusing process from the first focusing process to the second focusing process when the in-focus determination section has determined that the first focusing process has been accomplished.

24. A focus control method comprising:
controlling a focus of an optical system, and performing a first focusing process based on a first evaluation value;
controlling the focus of the optical system, and performing a second focusing process based on a second evaluation value;
determining whether or not the first focusing process has been accomplished when switching a focusing process between the first focusing process and the second focusing process; and
switching the focusing process from the first focusing process to the second focusing process when it has been determined that the first focusing process has been accomplished.
